(19) United States
(12) Patent Application Publication
(10) Pub. No.: US 2024/0067830 A1
(43) Pub. Date: Feb. 29, 2024

(54) STAIN-BLOCKING PAINTS, KITS, AND METHODS

(71) Applicant: SWIMC LLC, Cleveland, OH (US)

(72) Inventors: Hsuan-Chin WANG, Lake in the Hills, IL (US); Mary Jane HIBBEN, Elburn, IL (US); Andrew Balgeman, Woodstock, IL (US); Cynthia Escobar, Lake in the Hills, IL (US); Karl A. Booth, Mundelein, IL (US); Ashley Rodgers, Rockford, IL (US)

(21) Appl. No.: 18/237,612

(22) Filed: Aug. 24, 2023

Related U.S. Application Data
(60) Provisional application No. 63/400,707, filed on Aug. 24, 2022.

(51) Int. Cl. C09D 5/02; C08F 212/08; C08F 220/14; C08F 220/18; C09D 5/14; C09D 7/43; C09D 125/14; C09D 133/06; C09D 133/12

(52) U.S. Cl. CPC C09D 5/022; C08F 212/08; C08F 220/14; C08F 220/1804; C09D 5/14; C09D 7/43; C09D 125/14; C09D 133/062; C09D 133/12; C08F 2800/20

(57) ABSTRACT

Stain-blocking paints, kits, and methods that include a stain-blocking polymer, which is an emulsion latex polymer including interpolymerized monomers including: at least 1 wt-% t-butyl acrylate, based on the total weight of the interpolymerized monomers; optionally, one or more (meth)acrylate monomers selected from n-butyl (meth)acrylate, ethylhexyl (meth)acrylate, methyl (meth)acrylate, and combinations thereof; optionally, one or more wet adhesion monomers; and optionally, styrene.

### CROSS-REFERENCE TO RELATED APPLICATION

The present application claims the benefit of U.S. Provisional Patent Application Ser. No. 63/400,707, filed Aug. 24, 2022, which is incorporated herein by reference.

### BACKGROUND

Aqueous coating compositions have found limited success in providing coatings with desirable properties for multiple substrates. Typically, transitioning from solvent-borne compositions to aqueous coating compositions, while providing environmental advantages, have resulted in sacrificing properties. The balance of coating performance attributes required for a coating composition to be suitable for use on a variety of substrates is not easily achieved with aqueous coating compositions.

Accordingly, aqueous coating compositions have found limited success in providing coatings with desirable properties for forming paints with stain-blocking ability.

Substrates frequently contain soluble or mobile staining agents. Given the nature of water-based coatings, the staining agents often leach from the substrate into and/or through the coating, causing surface discoloration of the coating. For example, tannins contained in woods such as redwood, cedar, elm, merbau, and mahogany can leach from the substrate into the coating, causing tannin staining, which appears as discoloration on the surface of the coating. The visual appearance of localized stains or discoloration also can be manifested from extractives of previously coated substrates due to substrate exposure to water or humidity spots. In addition, salts contained in cementitious substrates often cause efflorescence, which is a staining caused by the migration of the salt from the substrate to the paint coating, where it appears as white deposits. Staining of the substrate, and of coatings previously applied to the substrate, can also be caused by sources external to the substrate. For example, cigarette smoke causes nicotine staining, which discolors light colored coatings; inks from pens cause marker stains on the substrate. Each of these types of staining is highly undesirable in coatings.

What is needed in the art are aqueous coating compositions that function as paints having improved stain-blocking performance.

### SUMMARY OF THE DISCLOSURE

The present disclosure provides stain-blocking paints, kits, and methods that include such stain-blocking paints, wherein the stain-blocking paints include an emulsion latex polymer.

In one embodiment, a stain-blocking paint (preferably, a topcoat paint, and in some embodiments, a paint-and-primer-in-one paint composition), is provided that includes: at least 10 wt-%, based on the total nonvolatile weight of the paint, of an emulsion latex polymer including interpolymerized monomers including: at least 1 wt-% (preferably, to less than 20 wt-%), based on the total weight of the interpolymerized monomers, of t-butyl acrylate and optionally one or more other acrylic acid ester monomers of Formula (I):

RO—C(O)—CH═CH₂

wherein: R is a branched alkyl group having a tertiary carbon atom, a cycloaliphatic group, or a combination thereof (in certain embodiments, and R has 20 or fewer carbon atoms); optionally, one or more (meth)acrylate monomers (i.e., acrylate or methacrylate monomers) selected from n-butyl (meth)acrylate, ethylhexyl (meth)acrylate, methyl (meth)acrylate, and combinations thereof; optionally, one or more wet adhesion monomers; and optionally, styrene; an aqueous carrier; and optionally, one or more additives selected from a surfactant, thickener, coalescent, biocide, mildewcide, colorant (e.g., inorganic pigment), and combinations thereof.

In another embodiment, a stain-blocking paint (preferably, a topcoat paint, and in some embodiments, a paint-and-primer-in-one paint composition) is provided that includes: an emulsion latex polymer including interpolymerized monomers including: at least 1 wt-% t-butyl acrylate and optionally one or more other acrylic acid ester monomers of Formula (I):

RO—C(O)—CH═CH₂

wherein: R is a branched alkyl having a tertiary carbon atom (in certain embodiments, R has 20 or fewer carbon atoms); at least 10 wt-% of one or more (meth)acrylate monomers selected from n-butyl (meth)acrylate, ethylhexyl (meth)acrylate, methyl (meth)acrylate, and combinations thereof; and at least 1 wt-% styrene; wherein the weight percentages are based on the total weight of the interpolymerized monomers.

In certain embodiments, a hardened coating formed from the stain-blocking paint described herein has one or more of the following properties:
a stain-blocking performance, based on the Stain-blocking Test described in the Examples Section (based on ASTM D7514-14), when the paint is a semi-gloss paint, characterized by a ΔE value of: at most 7 for a red permanent marker (e.g., Sharpie Red); and/or at most 22 for a black water-washable marker (e.g., Marks a Lot Black); and/or at most 22 for a blue water-washable marker (e.g., Window Marker Blue); and/or at most 17 for a green water-washable marker (e.g., Window Marker Green);
a stain-blocking performance, based on the Stain-blocking Test described in the Examples Section (based on ASTM D7514-14), when the paint is a flat paint, characterized by a ΔE value of: at most 15 for a red permanent marker (e.g., Sharpie Red); and/or at most 19 for a black water-washable marker (e.g., Marks a Lot Black); and/or at most 18 for a blue water-washable marker (e.g., Window Marker Blue); and/or at most 17 for a green water-washable marker (e.g., Window Marker Green);
an adhesion performance of at least 2 (whether for a wet or dry adhesion test, preferably, for a dry adhesion test, when the paint is a flat paint or a semi-gloss paint) based on the ASTM 3359-23 Cross-cut Adhesion Test described in the Examples Section; and
a scrub resistance of at least 600 cycles (whether the paint is a flat paint or a semi-gloss paint) based on ASTM 2486-17 Scrub Resistance Test described in the Examples Section.

In another embodiment, a stained substrate having a stain-blocking paint (preferably, a topcoat paint, and in some embodiments, a paint-and-primer-in-one paint composition) coated thereon is provided, wherein the stain-blocking paint is as described herein.

In another embodiment, is a kit for making a stain-blocking paint (preferably, a topcoat paint, and in some embodiments, a paint-and-primer-in-one paint composition) that includes: an emulsion latex polymer including interpolymerized monomers including: at least 1 wt-%, based on the total weight of the interpolymerized monomers, of t-butyl acrylate and optionally one or more other acrylic acid ester monomers of Formula (I):

RO—C(O)—CH═CH₂

wherein: R is a branched alkyl having a tertiary carbon atom, a cycloaliphatic group, or a combination thereof (in certain embodiments, R has 20 or fewer carbon atoms); optionally, one or more (meth)acrylate monomers selected from n-butyl (meth)acrylate, ethylhexyl (meth)acrylate, methyl (meth)acrylate, and combinations thereof; optionally, one or more wet adhesion monomers; and optionally, styrene; and instructions for forming a stain-blocking paint from the polymer.

In another embodiment, a method is provided that includes: causing a stain-blocking paint (preferably, a topcoat paint, and in some embodiments, a paint-and-primer-in-one paint composition) to be applied to a stained substrate, wherein the stain-blocking paint is as described herein.

The terms “polymer” and “polymeric material” include, but are not limited to, organic homopolymers, copolymers, such as for example, block, graft, random and alternating copolymers, terpolymers, etc., and blends and modifications thereof. Furthermore, unless otherwise specifically limited, the term “polymer” shall include all possible geometrical configurations of the material. These configurations include, but are not limited to, isotactic, syndiotactic, and atactic symmetries.

The term “stain” as used herein includes any mark, blemish, discoloration, or any deposit, whether or not visible or readily apparent to the naked eye. The term “stain” thus includes marks caused by inks, crayons, lipstick, grease pencils, smoke residue, tannins, water extracts, and the like. These stains may be found on residential or commercial walls as graffiti, markings from pens or color markers, on or native to wooden substrates, on wood-composite substrates, on concrete substrates, on paper substrates (such as wall board coverings), and on other substrates that are normally painted with one or more liquid coatings.

The term “stain-blocking” as used herein means binding, blocking or masking a stain where it cannot be seen, or is substantially less visible, once one or more liquid coatings are applied and dried, or in those cases where the stain is not visible or only slightly visible, that the stain cannot migrate through the one or more subsequently applied and dried liquid coatings. This is in contrast to a polymer or paint that is “stain-proof” or “stain-resistant” or “stain-repelling.”

Herein, the term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof).

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other claims are not useful, and is not intended to exclude other embodiments from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and in certain embodiments, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.) and any sub-ranges (e.g., 1 to 5 includes 1 to 4, 1 to 3, 2 to 4, etc.).

As used herein, the term “room temperature” refers to a temperature of 20° C. to 25° C.

The term “in the range” or “within a range” (and similar statements) includes the endpoints of the stated range.

Reference throughout this specification to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list. Thus, the scope of the present disclosure should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Although various theories and possible mechanisms may have been discussed herein, in no event should such discussions serve to limit the claimable subject matter.

### DETAILED DESCRIPTION OF ILLUSTRATIVE EMBODIMENTS

The present disclosure provides stain-blocking paints, kits, and methods that include such stain-blocking paints, wherein the stain-blocking paint includes a stain-blocking polymer that is an emulsion latex polymer.

In one embodiment, a stain-blocking paint is provided. As used herein, a paint is a coating composition that forms a continuous coating (e.g., by rolling, brushing, spraying) on a substrate such as wood (e.g., redwood, cedar, elm, merbau, and mahogany), metal (e.g., steel), etc., which adheres well. Typically, the paint is a topcoat paint.

In some embodiments, a stain-blocking paint composition is capable of functioning both as a primer and as a topcoat. With respect to architectural paints, such compositions are often referred to as a paint-and-primer-in-one. The stain-blocking latex polymers described herein may also be used in topcoat paints that are not paint-and-primer-in-one compositions. Such paint-and-primer-in-one compositions or non-priming topcoat paints may be, for example, clear, flat, eggshell, satin, semi-gloss, or high-gloss interior and/or exterior architectural paints. Herein, the stain-blocking paint is used to hide or block a staining agent in or on a substrate (i.e., a stained substrate) from showing through the topcoat. That is, the paint of the present disclosure acts as a barrier coating to a variety of underlying staining agents (whether polar or non-polar, hydrophilic or hydrophobic), such as tannins, inks, crayons, lipstick, grease pencils, smoke residue, water extracts, and the like, which can leach out of the underlying substrate. This is in contrast to surface staining and snail trails that result from a component (e.g., surfactant) leaching out of the topcoat.

Thus, the present disclosure also provides a stained substrate (i.e., a substrate such as wood containing a staining agent, such as tannins, inks, etc.) having a stain-blocking paint (preferably, a topcoat paint, and in some embodiments, a paint-and-primer-in-one paint composition) coated thereon. The substrate may include a metal, wood, wood composite, concrete, paper (such as wall board coverings), and other such substrates that are normally painted with one or more liquid coatings. In some embodiments, the substrate can be a primed surface and even a previously painted surface.

The paints of the present disclosure are aqueous coating compositions, preferably have a viscosity of 60-120 units measured by Krebs Viscometer at room temperature (suitable for spray, roll, or brush).

A hardened coating (i.e., dry film) formed from an aqueous composition in the form of a paint (preferably, a topcoat paint, and in some embodiments, a paint-and-primer-in-one paint composition) including a latex polymer (described herein) on a substrate surface (e.g., a wood or metal surface), preferably has one or more of the following properties:
a stain-blocking performance, based on the Stain-blocking Test described in the Examples Section (based on ASTM D7514-14), when the paint is a semi-gloss paint, characterized by a ΔE value of: at most 7 for a red permanent marker (e.g., Sharpie Red); and/or at most 22 for a black water-washable marker (e.g., Marks a Lot Black); and/or at most 22 for a blue water-washable marker (e.g., Window Marker Blue); and/or at most 17 for a green water-washable marker (e.g., Window Marker Green);
a stain-blocking performance, based on the Stain-blocking Test described in the Examples Section (based on ASTM D7514-14), when the paint is a flat paint, characterized by a ΔE value of: at most 15 for a red permanent marker (e.g., Sharpie Red); and/or at most 19 for a black water-washable marker (e.g., Marks a Lot Black); and/or at most 18 for a blue water-washable marker (e.g., Window Marker Blue); and/or at most 17 for a green water-washable marker (e.g., Window Marker Green);
an adhesion performance of at least 2 (whether for a wet or dry adhesion test, preferably, for a dry adhesion test, when the paint is a flat paint or a semi-gloss paint) based on the ASTM 3359-23 Cross-cut Adhesion Test described in the Examples Section (using a coating thickness of 3 mils (0.0762 mm) wet film on aluminum; and
a scrub resistance of at least 600, at least 800, or at least 1000 cycles (whether the paint is a flat paint or a semi-gloss paint) based on ASTM 2486-17 Scrub Resistance Test described in the Examples Section.

In certain embodiments, at least one of these colored marker (red, black, blue, or green) values is met by a hardened coating. In certain preferred embodiments, two of these four colored marker (red, black, blue, or green) values are met. In certain more preferred embodiments, three of these four colored marker (red, black, blue, or green) values are met. In certain even more preferred embodiments, all four of these colored marker (red, black, blue, or green) values are met.

Preferably, a hardened coating of the present disclosure includes all of these characteristics—stain-blocking performance, adhesion performance, and scrub resistance.

As previously discussed, in some embodiments the stain-blocking paint composition of the present disclosure is a paint-and-primer-in-one composition. In contrast to a conventional topcoat paint (i.e., a non-priming topcoat paint), preferred paint-and-primer-in-one compositions exhibit both good stain-blocking and good adhesion to unprimed surfaces (e.g., bare wood, bare drywall, and the like), while still exhibiting other desirable topcoat properties such as low tack, good hardness, good block resistance, good scrubability, and/or good washability. Preferred paint-and-primer-in-one compositions of the present disclosure exhibit an adhesion performance of at least 2 (whether for a wet or dry adhesion test, preferably, for a dry adhesion test, when the paint is a flat paint or a semi-gloss paint) based on the ASTM 3359-23 Cross-cut Adhesion Test described in the Examples Section. Preferred paint-and-primer-in-one compositions preferably also exhibit good stain-blocking performance in the Stain-blocking Test (e.g., at least the minimum ΔE values recited herein in conjunction with the Stain-blocking Test). In some embodiments, the paint-in-primer-in-one-composition exhibits such stain-blocking performance in the Stain-blocking Test when substituting the assessed paint-in-primer-in-one composition for the Flat Paint Formulation in the Stain-blocking Test and otherwise performing the testing the same.

The emulsion latex polymer (i.e., emulsion polymerized latex polymer) used in the paints of the present disclosure includes interpolymerized monomers including: at least 1 wt-%, or at least 2 wt-% (in certain embodiments, at least 1 wt-% to less than 20 wt-%), based on the total weight of the interpolymerized monomers, of tert-butyl acrylate (i.e., t-butyl acrylate); optionally, one or more (meth)acrylate monomers selected from n-butyl (meth)acrylate, ethylhexyl (meth)acrylate, methyl (meth)acrylate, and combinations thereof; optionally, one or more wet adhesion monomers; and optionally, styrene.

In certain embodiments, the t-butyl acetylate is used in a mixture with one or more acrylic acid ester monomers of Formula (I) other than t-butyl acrylate to form the emulsion latex polymer, wherein Formula (I) is:

RO—C(O)—CH═CH₂

wherein: R is a branched alkyl group having a tertiary carbon atom, a cycloaliphatic group, or a combination thereof.

In certain embodiments, the acrylic acid ester monomers of Formula (I) (other than t-butyl acrylate) have a homopolymer glass transition temperature (Tg) of less than 110° C., or less than 50° C. In certain embodiments, the acrylic acid ester monomers of Formula (I) have a homopolymer Tg of at least 20° C., or at least 30° C.

In certain embodiments, R of Formula (I) (which does not include t-butyl acrylate) is a branched alkyl group having a tertiary carbon atom, a cycloaliphatic group, or a combination thereof (e.g., a cyclohexane group with a t-butyl substituent).

In certain embodiments, R of Formula (I) (which does not include t-butyl acrylate) has no more than 20 carbon atoms (i.e., 20 or fewer carbon atoms), no more than 16 carbon atoms, no more than 12 carbon atoms, no more than 10 carbon atoms, no more than 6 carbon atoms, or no more than 4 carbon atoms.

In certain embodiments, R of Formula (I) (which does not include t-butyl acrylate) is a branched alkyl group having a tertiary carbon atom. In certain embodiments, R of Formula (I) is a branched alkyl group of 4 to 10 carbon atoms having a tertiary carbon atom.

In certain embodiments, the one or more monomers of Formula (I) (other than t-butyl acrylate) are selected from isobornyl acrylate, cyclohexyl acrylate, and a mixture thereof.

In certain embodiments, the emulsion latex polymer includes at least 1 wt-%, at least 2 wt-%, at least 5 wt-%, of t-butyl acrylate (optionally in combination with one or more other monomers of Formula (I)), based on the total weight of the interpolymerized monomers. In certain embodiments, the emulsion latex polymer includes less than 20 wt-%, up to 15 wt-% (including 15 wt-%), or up to 10 wt-%, of t-butyl acrylate (optionally in combination with one or more other monomers of Formula (I)), based on the total weight of the interpolymerized monomers.

Examples of ethylenically unsaturated monomers for use in forming the latex, in addition to t-butyl acrylate (optionally in combination with one or more other monomers of Formula 1), include, for example, acrylic acid, methacrylic acid, methyl acrylate, ethyl acrylate, propyl acrylate, n-butyl acrylate, 2-ethylhexyl acrylate, methyl methacrylate, ethyl methacrylate, propyl methacrylate, butyl methacrylate, 2-ethylhexyl methacrylate, hydroxyethyl acrylate, hydroxyethyl methacrylate, hydroxybutyl acrylate, hydroxybutyl methacrylate, glycidyl methacrylate, 4-hydroxybutyl acrylate glycidyl ether, 2-(acetoacetoxy)ethyl methacrylate (AAEM), diacetone acrylamide (DAAM), acrylamide, methacrylamide, methylol (meth)acrylamide, styrene, α-methyl styrene, vinyl toluene, vinyl acetate, vinyl propionate, allyl methacrylate, and mixtures thereof. Preferred monomers include styrene, methyl acrylate, methyl methacrylate, ethyl acrylate, methacrylic acid, DAAM, AAEM, n-butyl acrylate, tert-butyl methacrylate, n-butyl methacrylate, esters of itaconic acid, vinyl acetate, 2-ethyl hexyl acrylate, bio-renewable monomers, and the like. Examples of suitable polyfunctional acrylates include, for example, di-, tri- and tetra-functional acrylates such as dipropylene glycol diacrylate (DPGDA), propoxylated glyceryl triacrylate (GPTA), pentaerythritol tetraacrylate, dipentaerythritol tetraacrylate, mixtures thereof, and the like.

In some embodiments, the latex polymer is formed from interpolymerized monomers including at least 80 wt-% of two or more monomers selected from methyl methacrylate, ethyl acrylate, vinyl acetate, tert-butyl methacrylate, n-butyl methacrylate, styrene, n-butyl acrylate, 2-ethyl hexyl acrylate, methyl acrylate, and esters of itaconic acid, based on the total weight of the interpolymerized monomers.

In certain embodiments, the interpolymerized monomers of the emulsion latex polymer include one or more (meth)acrylate monomers selected from n-butyl (meth)acrylate, ethylhexyl (meth)acrylate, methyl (meth)acrylate, and combinations thereof. In certain embodiments, the emulsion latex polymer includes at least 10 wt-%, at least 20 wt-%, at least 30 wt-%, at least 40 wt-%, at least 50 wt-%, at least 60 wt-%, at least 70 wt-%, at least 75 wt-%, at least 80 wt-%, at least 83 wt-%, at least 84 wt-%, least 85 wt-%, or at least 90 wt-%, of these one or more (meth)acrylate monomers (e.g., two or more (meth)acrylate monomers), based on the total weight of the interpolymerized monomers. In certain embodiments, the emulsion latex polymer includes up to 99 wt-%, up to 98 wt-%, or up to 95 wt-%, of these one or more (meth)acrylate monomers (e.g., two or more (meth)acrylate monomers), based on the total weight of the interpolymerized monomers.

In certain embodiments, the interpolymerized monomers of the emulsion latex polymer include one or more wet adhesion monomers. Examples of wet adhesion monomers include N-(2-methacryloyloxyethyl) ethylene urea (available as a 50% aqueous solution under the tradename SIPOMER WAM E W 50, as a 50% methyl methacrylate solution under the tradename SIPOMER WAM E MMA50, or as a 25% methyl methacrylate solution under the tradename SIPOMER WAM E MMA25, all from Solvay), 1-(2-((3-(allyloxy)-2-hydroxypropyl)amino)ethyl)imidazolidine-2-one (available as a 90 wt-% aqueous solution under the tradename SIPOMER WAM from Solvay), N-(2-methacryloyloxyethyl) ethylene urea (available as a 50% aqueous solution under the tradename VISIOMER MEEU 50 W from Evonik Industries AG), and combinations thereof. In certain embodiments, the emulsion latex polymer includes at least 0.2 wt-% of one or more wet adhesion monomers, based on the total weight of the interpolymerized monomers. In certain embodiments, the emulsion latex polymer includes up to 2.0 wt-%, or up to 1.0 wt-%, of one or more wet adhesion monomers, based on the total weight of the interpolymerized monomers.

In certain embodiments, the interpolymerized monomers of the emulsion latex polymer include styrene. In certain embodiments, the emulsion latex polymer includes at least 1 wt-%, at least 5 wt-%, at least 10 wt-%, or at least 15 wt-%, styrene, based on the total weight of the interpolymerized monomers. In certain embodiments, the emulsion latex polymer includes up to 75 wt-%, or up to 50 wt-% styrene, based on the total weight of the interpolymerized monomers.

In certain embodiment, the interpolymerized monomers of the emulsion latex polymer include a crosslinking monomer. Examples of suitably crosslinking monomers include acrolein, methacrolein, diacetone acrylamide (DAAM), diacetone methacrylamide, 2-butanone methacrylate, formyl styrol, diacetone acrylate, diacetone methacrylate, acetonitrile acrylate, acetoacetoxyethyl methacrylate, acetoacetoxyethyl acrylate, vinylacetoacetate, and combinations thereof; with preferred such monomers including diacetone acrylamide (DAAM), 2-(acetoacetoxy)ethyl methacrylate (AAEM), and combinations thereof. When used, such one or more crosslinking monomers are typically used in an amount of at least 0.1 wt-%, at least 0.5 wt-%, at least 1.0 wt-%, and preferably at least 2.5 wt-%, based on the total weight of the interpolymerized monomers. While the upper amount of such one or more crosslinking monomers may vary widely, typically the one or more crosslinking monomers are present in the latex copolymer in an amount of 10 wt-% or less, 9 wt-% or less, 8 wt-% or less, 7 wt-% or less, 6 wt-% or less, or 5 wt-% or less, based on the total weight of the interpolymerized monomers.

In certain embodiments, DAAM is one of the interpolymerized monomers of the emulsion latex polymer used in the paints of the present disclosure. In certain embodiments, the interpolymerized monomers include at least 1 wt-% of DAAM, based on the total weight of the interpolymerized monomers.

In embodiments in which DAAM is used, a dihydrazide is preferably also included in the composition. Adipic dihydrazide (ADH) is a preferred dihydrazide. In some embodiments, a corresponding amount of dihydrazide for the amount of DAAM is included (e.g., slightly less than stoichiometric amount of dihydrazide relative to DAAM).

In certain embodiments, the interpolymerized monomers include one or more bio-based monomers. “Bio-based,” as used with respect to monomers herein, refers to monomers that are preferably obtained from bio-renewable olefinically unsaturated monomers. Such bio-renewable olefinically unsaturated monomers have a carbon-14 (C-14) that is significantly higher than olefinically unsaturated monomers derived from fossil fuels. This is because C-14 has a relatively short half-life on the scale of the age of fossil-fuel-based materials. Thus, “bio-renewable” monomers as used herein mean monomers for which the level of C-14 isotope is comparable to the mean level of C-14 in atmospheric CO₂, as measured by ASTM D6866 or having at least 1.5 dpm/gC (disintegrations per minute per gram carbon), at least 2.5 dpm/gC, or at least 3.0 dpm/gC of C-14, as measured through liquid scintillation counting. Exemplary such bio-based monomers include esters of itaconic acid, bio-derived (meth)acrylic acid, and alkyl (meth)acrylic acid. In some embodiments, bio-based monomers make up at least 20 wt-%, at least 30 wt-%, or at least 40 wt-% of the latex copolymer by weight of the interpolymerized monomers.

In certain embodiments, the paints described herein include a stain-blocking emulsion latex polymer that includes interpolymerized monomers including: at least 1 wt-%, or at least 2 wt-%, of t-butyl acrylate (optionally with one or more acrylic acid ester monomers of Formula (I) (other than t-butyl acrylate):

RO—C(O)—CH═CH₂

wherein: R is a branched alkyl having a tertiary carbon atom (in certain embodiments, R has 20 or fewer carbon atoms)); at least 10 wt-% of one or more (meth)acrylate monomers selected from n-butyl (meth)acrylate, ethylhexyl (meth)acrylate, methyl (meth)acrylate, and combinations thereof; and at least 1 wt-%, at least 5 wt-%, at least 10 wt-%, or at least 15 wt-%, styrene; wherein the weight percentages are based on the total weight of the interpolymerized monomers.

In certain embodiments, the latex polymer is a single stage latex polymer. In certain embodiments, the latex polymer is a multistage latex polymer, such as a gradient Tg latex polymer or a core-shell(s) latex polymer. In certain embodiments, the emulsion latex polymer is a two- or more-stage emulsion latex polymer (e.g., resulting from a power feed process).

In this context, the term “multistage” when used with respect to a latex polymer means the polymer was made using discrete charges of two or more monomers, made using a varying (e.g., continuously varying) charge of two or more monomers, or made using a combination of both discrete charges and varying charges of two or more monomers. A multistage polymer is distinct from a single stage polymer made using one type of monomer blend with distinct polymer seed particles. Frequently, a multistage polymer consists of polymer stages with different Tg's, where the higher Tg stages are considered the hard stages and the lower Tg stages are considered the soft stages.

Usually, a multistage latex will not exhibit a single Tg inflection point as measured by differential scanning calorimetry (DSC). For example, a DSC curve for a multistage latex made using discrete charges of two or more monomers may exhibit two or more Tg inflection points. Also, a DSC curve for a multistage latex made using a continuously varied charge of two or more monomers may exhibit no Tg inflection points. By way of further explanation, a DSC curve for a single stage latex made using a single monomer charge or a non-varying charge of two monomers may exhibit only a single Tg inflection point. Occasionally when only one Tg inflection point is observed it may be difficult to determine whether the latex represents a multistage latex. In such cases a lower Tg inflection point may sometimes be detected on closer inspection, or the synthetic scheme used to make the latex may be examined to determine whether or not a multistage latex would be expected to be produced.

In certain embodiments, latex polymers (whether single stage or multistage) are typically made using seed particles as a nucleating agent for polymerization. Such seed particles may be in the form of inorganic particulate seed (e.g., clay or glass particles), preformed particulate polymer seed (latex or non-latex polymer seed), or particulate seed polymer formed in situ. Polymer seed can be an emulsion polymerized polymer seed, but does not encompass polymeric surfactant. In certain embodiments, seed particles are used in an amount of no more than 10 wt-%, or no more than 5 wt-%, based on latex polymer solids in the final latex.

Herein, whether inorganic particulate seed, preformed particulate polymer seed, or particulate seed polymer formed in situ, such seed particles will not be deemed to provide a stage of a multistage polymer or to provide a basis for designating a single stage polymer made using such seed polymer as a multistage polymer.

In certain embodiments, the t-butyl acrylate and optional one or more other monomers of Formula (I) are present in a hard stage of the emulsion latex polymer.

Latex polymers described herein may or may not have a glass transition temperature that is measurable. As used herein, the term “glass transition temperature” or “Tg” refers to the temperature at which an amorphous, solid material undergoes a reversible transition to a molten, rubber-like state. The Tg may be measured using DSC, or calculated using the Fox equation. Application of the Fox equation to estimate the Tg of polymers is well known to one skilled in the art.

In certain embodiments, the latex polymer has a measured Tg, as measured by DSC. Such Tg may be measured at the beginning, mid-point, or end of polymerization. In certain embodiments, however, the latex polymer may have no clearly measurable Tg. Thus, a latex polymer may be referred to as a “gradient Tg polymer,” it may not have a clearly measurable Tg using DSC.

In certain embodiments, the latex polymer is a multistage polymer having at least one measured Tg and at least one Fox Tg (which are not alternative representations of the same glass transition). Herein, “Fox Tg” and “calculated Tg” and “calculated Fox Tg” are used interchangeably.

The Tg of a particular stage, or combination of stages, can be estimated (i.e., calculated) using the Fox equation. For example, for a polymer made from two monomers in a particular stage, the theoretical Tg may be calculated using the Fox equation as follows:

1/Tg=Wa/Tga+Wb/Tgb

wherein:
Tga and Tgb are the respective glass transition temperatures in Kelvin of homopolymers made from monomers “a” and “b”; and
Wa and Wb are the respective weight fractions of polymers “a” and “b”.
   When additional monomer feeds “c” and “d” and so on are employed, additional fractions Wc/Tgc, Wd/Tgd and so on are added to the right-hand side of the above equation. Unless indicated otherwise, the “calculated” stage or copolymer Tg's referenced herein are calculated using the Fox equation. Also, the calculation is based on all of the monomers that are reacted together to form a stage, and not upon merely a portion of such monomers.

The value of Tg of the monomers used to estimate the polymer Tg are based on literature values. Typically, there is some variation of the Tg values of the homopolymers of monomers listed in such literature. The difference arises from the test method used to measure the Tg. The differences also arise from influence of comonomers polymerized together. For the purposes of this disclosure, the values used for the homopolymer Tg of certain monomers, particularly monomers used in the examples are listed herein (e.g., in the Materials Table in the Examples Section). Alternatively, the method of determining the Tg of a homopolymer can be determined using the DSC procedure described in the Examples Section, particularly if the literature values are significantly different (e.g., the literature values vary by at least 15° C.). If the literature values vary by less than 15° C., then use the lower literature value.

In certain embodiments, the multistage polymer is a gradient latex polymer (i.e., gradient Tg latex polymer). Typically, a gradient Tg latex polymer will have a DSC (differential scanning calorimetry) curve that exhibits no Tg inflection points, and could be said to have an essentially infinite number of Tg stages. For example, one may start with a high Tg monomer feed and then at a certain point in the polymerization start to feed a low Tg soft stage monomer composition into the high Tg hard stage monomer feed. The resulting multistage latex polymer will have a gradient Tg from high to low. In other embodiments, it may be favorable to feed a high Tg hard stage monomer composition into a low Tg soft stage monomer composition.

In some embodiments, a multistage latex described herein will contain at least 10 wt-%, at least 20 wt-%, or at least 25 wt-%, of high Tg or hard stage monomers. In some embodiments, a multistage latex described herein will include up to 50 wt-%, up to 40 wt-%, or up to 35 wt-%, of high Tg or hard stage monomers. In some embodiments, a multistage latex described herein will include at least 50 wt-%, at least 60 wt-%, or at least 65 wt-%, of low Tg or soft stage monomers. In some embodiments, a multistage latex described herein will include up to 90 wt-%, up to 80 wt-%, or up to 75 wt-%, of low Tg or soft stage monomers. Thus, in certain preferred embodiments, the multistage latex includes from 20 to 40 wt-%, or from 25 to 35 wt-%, of high Tg or hard stage monomers and from 80 to 60 wt-%, or from 75 to 65 wt-% of low Tg or soft stage monomers, based on the total weight of monomers used to make the respective stage relative to the total weight of the monomers used to make the hard and soft stages.

In certain aspects, a multistage latex described herein preferably includes at least two polymer portions, e.g., a first stage and a second stage, with different Tg values, where the difference in Tg (ΔTg) is at least 35° C., at least 50° C., or at least 60° C., or at least 65° C. In certain aspects, the ΔTg is less than 200° C., less than 150° C., or less than 100° C.

In certain aspects, a multistage latex described herein preferably has a first stage (e.g., a soft stage) having a Fox Equation Tg of −45° C. to 10° C. (preferably, −45° C. to 0° C.) and a second stage (e.g., a hard stage) having a Fox Equation Tg of from 30° C. to 80° C. (preferably, 45° C. to 70° C.). The first and second stages can be polymerized in any order. For example, in some embodiments the first stage is polymerized first, whereas in other embodiments the second stage is polymerized first. Thus, in some embodiments, for example, the hard stage is located towards the interior of the latex particle (e.g., as the “core” stage in a core/shell latex particle) and the soft stage is located towards the exterior of the latex particles (e.g., as a “shell” stage in a core/shell latex particle).

A gradient Tg polymer may also be used in conjunction with multiple Tg polymers. For gradient Tg latex polymers, a Tg differential may be determined by using the Fox equation to calculate the theoretical Tg for a copolymer made from the monomer feed at the start of polymerization and comparing the result to the calculated theoretical Tg for a copolymer made from the second feed. Such gradient Tg can result from the second monomer feed being combined into the first monomer feed to form a gradient architecture, or ultimately result from two monomer feeds being combined at differential rates (e.g., the rate of one monomer feed increases while the rate of a second monomer feed decreases).

In certain embodiments, there may be a discrete measurable Tg of an otherwise gradient Tg latex polymer, such discreet Tg is typically corresponding to the polymer resulting from polymerization of the first monomer feed, or to a mixture of the first monomer feed and a small amount of the second monomer feed.

In certain embodiments, the emulsion latex polymer used in the paints of the present disclosure is a single stage latex polymer that has a Fox Equation (theoretical calculated) Tg of from −10° C. to 40° C. such as, for example, from −10° C. to 20° C. or −5° C. to 10° C. In some such embodiments, such a single stage latex polymer is used to formulate a paint-and-primer-in-one interior or exterior paint.

In certain embodiments, the emulsion latex polymer used in the paints of the present disclosure has an acid number of up to 30 (mg KOH/gram sample). In certain embodiments, the emulsion latex polymer of the present disclosure has an acid number of at least 5 (mg KOH/gram sample).

In certain embodiments, the emulsion latex polymer used in the paints of the present disclosure includes latex particles having a volume average particle size of at least 50 nm, or at least 60 nm, or at least 70 nm. In certain embodiments, the emulsion latex polymer of the present disclosure includes latex particles having a volume average particle size of up to 150 nm, or up to 130 nm.

Latex polymers may be made from the described monomers using a variety of techniques known to one skilled in the art. Typically, such polymers are made from an aqueous emulsion that includes one or more monomers as described herein, preferably using a multistage feed process. In certain embodiments, after the latex polymer is formed in water, more water may be added to obtain a desired solids level.

Such multistage feed processes (e.g., powerfeed methods) for producing emulsion copolymers are well-known. They enable one to constantly vary the composition of monomers being polymerized to produce copolymers having a variety (e.g., gradient) of desired properties. For example, in certain embodiments a gradient is achieved by changing the feed rate of a second monomer mixture into a first monomer mixture.

There is no required order of mixing monomers or required combination of monomers. Furthermore, there is no requirements regarding which monomers may be mixed with which monomers. In certain preferred embodiments, however, the one or more monomers of Formula (I) are added in the first stage of a multistage process.

In certain embodiments, the latex polymer is formed from components that also include one or more radical transfer agents (i.e., chain transfer agents), although such agent is not required. In certain embodiments, the radical transfer agents are selected from dodecanethiol, mercaptopropionic acid, isooctyl thioglycolate, butyl mercapto propionate, and combinations thereof. In certain embodiments, the one or more radical transfer agents are present in an amount of at least 0.1 wt-%, based on the total weight of monomers, although typically, no radical transfer agent is needed. If used, in certain embodiments, the one or more radical transfer agents are present in an amount of up to 0.5 wt-%, based on the total weight of monomers.

In certain embodiments, the stain-blocking paint (preferably, topcoat paint, and in certain embodiments, paint-and-primer-in-one) includes at least 10 wt-%, or at least 15 wt-% of a stain-blocking polymer (as described herein), which is an emulsion latex polymer, based on the total nonvolatile weight of the paint. In certain embodiments, the stain-blocking paint (preferably, topcoat paint, and in certain embodiments, paint-and-primer-in-one) includes up to 50 wt-%, or up to 30 wt-% of a stain-blocking polymer (as described here), which is an emulsion latex polymer, based on the total nonvolatile weight of the paint.

The stain-blocking paint (preferably, topcoat paint, and in certain embodiments, paint-and-primer-in-one) of the present disclosure also includes an aqueous carrier (e.g., water and one or more optional organic solvents), and optionally, one or more additives selected from a surfactant, thickener, biocide, mildewcide, colorant (e.g., inorganic pigment), and combinations thereof.

In certain embodiments, the stain-blocking paint (preferably, topcoat paint, and in certain embodiments, paint-and-primer-in-one) includes water in an amount of at least 50 wt-%, based on the total weight of the paint. In certain embodiments, the stain-blocking paint (preferably, topcoat paint, and in certain embodiments, paint-and-primer-in-one) includes water in an amount of up to 90 wt-%, based on the total weight of the paint.

In certain embodiments, the stain-blocking paint (preferably, topcoat paint, and in certain embodiments, paint-and-primer-in-one) of the present disclosure includes a substantial amount of water and may further include one or more optional organic solvents. Such paints may be referred to herein as aqueous coating compositions. In some embodiments, water constitutes greater than 20 wt-%, or greater than 35 wt-%, or greater than 50 wt-%, of the total weight of the aqueous carrier. In some embodiments, water constitutes 100 wt-% or less, less than 95 wt-%, or less than 90 wt-%, of the total weight of the aqueous carrier.

Suitable optional organic solvents include ketones, glycol ethers, esters, alcohols, aromatics, and combinations thereof. Examples of such solvents include carbitol, butyl carbitol, butylcellosolve, propylene glycol monomethyl ether, dibasic ester, ethyl carbitol, diisobutyl ketone, dipropylene glycol n-butyl ether (DPNB), and 2,2,4-trimethyl-1,3-pentanediol monoisobutyrate (available under the tradename TEXANOL), and mixtures thereof.

In certain embodiments, the stain-blocking paint (preferably, topcoat paint, and in certain embodiments, paint-and-primer-in-one) includes one or more additives selected from a surfactant (e.g., fluorinated surfactants, non-fluorinated surfactants, ethylenically unsaturated surfactants), thickener (e.g., to allow the polymer to coat out on a substrate surface), coalescent (e.g., a glycol ether such as EASTMAN EP, EASTMAN DM, EASTMAN DE, EASTMAN DP, EASTMAN DB and EASTMAN PM from Eastman Chemical Co., an ester alcohol such as TEXANOL ester alcohol from Eastman Chemical Co., or a low VOC coalescent compound such as is described in U.S. Pat. No. 6,762,230 B2), biocide, mildewcide, colorant (e.g., inorganic pigment such as CaCO₃, TiO₂), and mixtures thereof. In certain embodiments, the paint includes one or more additives for wet hide capability (e.g., titanium dioxide particles, opaque polymeric spheres, and kaolin clay platelets). Such additives may be added during polymerization or after polymerization.

In some embodiments, the stain-blocking paint includes a non-fluorinated, non-polymeric additive selected from the salt of one or more alkyl phosphates, alkyl phosphonates, alkyl phosphate esters, alkyl sulfates, alkyl sulfonates, alkyl sulfate esters, or a combination thereof. Examples of suitable such additives are included in the Stepan STEPCOTE multi-functional wetting agent line of products (available from the Stepan Company, Northfield, IL), with representative such examples including STEPCOTE W-846, STEPCOTE W-849, STEPCOTE W-888, STEPCOTE W-839, STEPCOTE W-843, STEPCOTE W-877, STEPCOTE W-119, or the B-681 product also from Stepan.

In certain embodiments, one or more additives may be present in an amount of at least 0.1 wt-%, at least 0.5 wt-%, or at least 1 wt-%, based on the total weight of polymer solids. In certain embodiments, one or more additives may be present in an amount of up to 5 wt-%, up to 4 wt-%, up to 3 wt-%, up to 2 wt-%, or up to 1 wt-%, based on the total weight of polymer solids.

Preferred stain-blocking paints described herein include less than 0.01 wt-%, if any, of fluorosurfactants, based on the total weight of the composition. As used herein, the term “fluorosurfactant” refers to synthetic organofluorine compounds with one or more fluorine atoms, more typically multiple fluorine atoms. Such compounds can be polyfluorinated, perfluorinated (i.e., fluorocarbons), or partially fluorinated, and typically include a hydrophilic head and a fluorinated/hydrophobic tail. Fluorosurfactants may be anionic or nonionic. Conventionally used fluorosurfactants include, for example, fluoroalkanes, perfluoroalkanes, their derivatives, and the like. The term “fluorosurfactant” as used herein, also includes short chain fluorinated compounds, such as, for example, C1-C10 fluorinated compounds. In some embodiments, the paint contains less than 1000 parts per billion (ppb) of elemental fluorine as it occurs in all chemical species in the composition, if any is present.

In certain embodiments, stain-blocking paints of the present disclosure are low VOC paints. By controlling the type of monomers selected for the feed process, a multistage latex suitable for low VOC, paints may be formed. The phrase “low VOC” when used with respect to a paint means that the paint contains less than 10 weight percent (wt-%) volatile organic compounds, more preferably less than 7 wt-% volatile organic compounds, and most preferably less than 4 wt-% volatile organic compounds, based upon the total paint weight. The term “volatile organic compound” (“VOC”), as defined by the Environmental Protection Agency (EPA) in 40 C.F.R. 51.100(s), refers to any compound of carbon, excluding carbon monoxide, carbon dioxide, carbonic acid, metallic carbides or carbonates, and ammonium carbonate, which participates in 20 atmospheric photochemical reactions. Typically, volatile organic compounds have a vapor pressure equal to or greater than 0.1 mm Hg. As used herein, “volatile organic compound content” (“VOC content”) is as measured by ASTM method D2369-90, refers to the weight of VOC per volume of the coating solids, and is reported, for example, as grams VOC per liter (g/L).

In certain embodiments, the stain-blocking paint is a clear (i.e., unpigmented) paint.

Pigments and fillers may also be added to a coating composition of the present disclosure (via a pigment grind) to provide a desired opacity, hiding characteristics, or PVC. In some embodiments, the paint is a pigmented paint composition such as, for example, a pigmented paint-and-primer-in-one interior and/or exterior architectural paint. The term “pigment volume concentration” (PVC) when used in respect to a paint, stain or colorant means the total percentage of dried coating volume occupied by all pigment species in the coating. In some embodiments, the paint has a PVC of more than 0%, 5% or more, 10% or more, 18% or more, 25% or more, 35% or more, or 40% or more.

Generally, the more highly pigmented and/or filler-rich a paint formulation is, the worse the stain-blocking capability of the paint. This is mainly believed to be caused by a more porous paint film when more pigments/fillers are present. There is also relatively less polymer, which provides much, and typically most, of the stain-blocking, in the system. Flat paints, which typically have a PVC range of 30 wt-% to 60 wt-%, tend to be the most susceptible to stain bleed through, with high gloss paints, which typically have a PVC range of 0 wt-% to 2 wt-%, being the least susceptible, and semi-gloss paints, which typically have a PVC range of 10 wt-% to 30 wt-%, being of intermediate susceptibility. Thus, the use of a stain-blocking polymer described herein is beneficial in high gloss paints, more beneficial in semi-gloss paints, and even more beneficial in flat paints.

In certain preferred embodiments, the stain-blocking polymer disclosed herein is suitable for use in a low-VOC or zero-VOC paint to be colored or tinted to a desired color and finish, such as an in-store tintable base paint (e.g., in-store tintable paint-and-primer-in-one), for example. In some embodiments, the paint or other paint may include one or more pigments, including pigments or fillers used to tone or opacify the in-store tintable base paint. Suitable examples of pigments include, without limitation, titanium dioxide white, carbon black, lamp black, black iron oxide, red iron oxide, yellow iron oxide, brown iron oxide (a blend of yellow and red oxide with black oxide), phthalocyanine green, phthalocyanine blue, organic reds (such as naphthol red, quinacridone red and toluidine red), quinacridone magenta, quinacridone violet, DNA orange, and/or organic yellows (such as Hansa yellow), for example.

Pigments may be supplemented with extenders or fillers such as talc, china clay, barytes, carbonates, silicates and mixtures thereof, for example magnesium silicates, calcium carbonate, aluminosilicates, silica and various clays; organic materials including plastic beads (e.g., polystyrene or polyvinyl chloride beads), microspherical materials containing one or more voids, and vesiculated polymer particles (e.g., those discussed in U.S. Pat. Nos. 4,427,835, 4,920,160, 4,594,363, 4,469,825, 4,468,498, 4,880,842, 4,985,064, 5,157,084, 5,041,464, 5,036,109, 5,409,776, and 5,510,422). Other exemplary extenders or fillers include EXPANCEL™ 551DE20 acrylonitrile/vinyl chloride expanded particles (from Expancel Inc.), SIL-CEL 43 glass micro cellular fillers (from Silbrico Corporation), FILLITE 100 ceramic spherical particles (from Trelleborg Fillite Inc.), SPHERICEL hollow glass spheres (from Potter Industries Inc.), 3M ceramic microspheres including grades G-200, G-400, G-600, G-800, W-210, W-410, and W-610 (from 3M), 3M hollow microspheres including 3M Performance Additives iM30K (also from 3M), INHANCE UH 1900 polyethylene particles (from Fluoro-Seal Inc.), and BIPHOR aluminum phosphate (from Bunge Fertilizantes S.A., Brazil).

In some embodiments, the paint compositions, and particularly paint-and-primer-in-one compositions, described herein may include a UV-VIS absorber (e.g., ultraviolet absorber, visible light absorber, or a combination thereof). These are often referred to as photoinitiators. Preferred UV-VIS absorbers are water-insoluble. By this it is meant that the compounds will not dissolve to an appreciable extent (e.g., will not dissolve in an amount of more than 5 wt-%) in water at the temperatures typically used for preparing paint compositions as described herein.

Examples of suitable UV-VIS absorbers are those compounds capable of absorbing ultraviolet and/or visible radiation within a range of 240-465 nanometers (nm). For certain embodiments, they are capable of absorbing radiation in the 280-450 nm range. In certain embodiments, suitable visible light absorbers are those compounds capable of absorbing visible radiation within a range of 420-450 nm. In certain embodiments, suitable ultraviolet absorbers are those compounds capable of absorbing UV radiation within a range of 240-400 nm. For certain embodiments, they are capable of absorbing UV radiation in the 280-400 nm range, and for certain embodiments in the 315-375 nm range.

Herein, the UV-VIS (preferably, ultraviolet) absorbers typically do not form a bond to the latex copolymer, although they are capable of generating a radical through a hydrogen-abstraction mechanism by absorbing UV-VIS (typically, UV) radiation. Although not wishing to be bound by theory, it may be that this results in surface crosslinking of the latex copolymer. Examples of suitable ultraviolet absorbers include the following: Benzophenone (available from Lamberti, Gallaratte, Italy); Phenylbis(2,4,6-trimethylbenzoyl)phosphine oxide (available under the trade name IRGACURE 819DW from BASF, Florham Park, N.J.); Ethyl-2,4,6-trimethylbenzoylphenylphosphinate (available under the trade name LUCIRIN TPO-L (formerly: LUCIRIN LR 8893) from BASF, Florham Park, N.J.); 2,4,6-trimethylbenzophenone & 4-methylbenzophenone (available as a mixture under the trade name ESACURE TZT from Lamberti, Gallaratte, Italy); 2,2-Dimethoxy-1,2-diphenylethanone (i.e., Benzildimethylketal) (available under the trade name ESACURE KB 1 from Lamberti); 1-Hydroxycyclohexyl phenyl ketone (i.e., a-hydroxycyclohexylphenylketone) (available under the trade name ESACURE KS 300 from Lamberti); 2-Hydroxy-2-methyl-1-phenyl-1-propanone (available under the trade name ESACURE KL 200 from Lamberti); Polymeric Benzophenone (available under the trade name EBECRYL P39 from Cytec, Woodland Park, N.J.); Isopropylthioxanthone (available under the trade name GENOCURE ITX from Rahn USA, Aurora, IL); Methyl-o-benzoyl-benzoate (available under the trade name GENOCURE MBB from Rahn); Methylbenzoylformate (available under the trade name GENOCURE MBF from Rahn); Benzoin ethyl ether (available from Aldrich. St. Louis, MO); 4′-Ethoxyacetophenone (from Aldrich. St. Louis, MO); and combinations thereof. Other suitable UV-VIS absorbers are available commercially from BASF under the trade designations IRGACURE and LUCERIN. Methyl-o-benzoyl-benzoate is a preferred UV-VIS absorber for, e.g., improving gloss retention and/or dirt pick-up resistance.

In some embodiments, the stain-blocking paints of the present disclosure include at least 0.1 wt-%, or at least 0.3 wt-%, or at least 0.5 wt-%, of one or more UV-VIS (preferably, ultraviolet) absorbers, based on the weight of total resin solids. In certain embodiments, the water-based compositions of the present disclosure include up to 5.0 wt-%, or up to 3.0 wt-%, or up to 1.5 wt-%, or up to 1.0 wt-%, of one or more UV-VIS (preferably, ultraviolet) absorbers, based on the weight of total resin solids.

The present disclosure also provides a kit for making a stain-blocking paint. The kit includes an emulsion latex polymer described herein and instructions for forming a stain-blocking paint as described herein. The emulsion latex polymer and the instructions are typically physically packaged together; however, the two do not need to be physically delivered together in a physical package to be a kit.

The present disclosure also provides a method (e.g., a method of blocking stains). The method includes causing a stain-blocking polymer as described herein in a paint (preferably, in a topcoat paint, and in certain embodiments, in a paint-and-primer-in-one) to be applied to a stained substrate (i.e., a substrate that has a stain or a staining agent therein or thereon). Herein, “causing” means applying the paint to the stained substrate, instructing it to be applied to the stained substrate, or supplying it to a user to apply it to a stained substrate.

Typically, the method also includes causing a paint that includes a stain-blocking polymer to be applied to a stained substrate, and drying or allowing the paint to harden to form a hardened stain-blocking coating and block the stain (i.e., form a barrier for the staining agent to show through a topcoat).

The step of applying the paint may be any of a wide variety of coating techniques known to one skilled in the art.

The step of allowing a paint to harden and form a hardened coating may include exposing the paint to a wide variety of conditions known to one skilled in the art. Typically, such conditions include exposing the paint to a temperature of at least 10° C., and in certain embodiments up to 100° C., for a period of time of at least 60 minutes and up to 168 hours. For example, such conditions may include hardening (e.g., drying or curing) the paint at a temperature of at least 10° C. for at least 168 hours. Alternatively, such conditions may include using a temperature of no more than (i.e., up to) 100° C. for no more than (i.e., up to) 60 minutes. Such hardening may occur in one or more steps.

A coated (e.g., painted) stained substrate including a substrate surface having a hardened coating disposed thereon is provided by the present disclosure. Such coated stained substrate may be prepared by this method.

### Exemplary Embodiments

In certain embodiments (embodiment 1), a stain-blocking paint is provided that includes: at least 10 wt-%, based on the total nonvolatile weight of the paint, of an emulsion latex polymer comprising interpolymerized monomers comprising: at least 1 wt-%, based on total weight of monomers, of t-butyl acrylate and optionally one or more acrylic acid ester monomers of Formula (I) (other than t-butyl acrylate):

RO—C(O)—CH═CH₂

wherein: R is a branched alkyl group having a tertiary carbon atom, a cycloaliphatic group, or a combination thereof; optionally, one or more (meth)acrylate monomers selected from n-butyl (meth)acrylate, ethylhexyl (meth)acrylate, methyl (meth)acrylate, and combinations thereof; optionally, one or more wet adhesion monomers; and optionally, styrene; an aqueous carrier; and optionally, one or more additives selected from a surfactant, thickener, coalescent, biocide, mildewcide, colorant (e.g., inorganic pigment), and combinations thereof.

In certain embodiments (embodiment 2), a paint of embodiment 1 is provided that includes an emulsion latex polymer comprising interpolymerized monomers comprising: at least 1 wt-%, based on total weight of monomers, of t-butyl acrylate and one or more acrylic acid ester monomers of Formula (I) (other than t-butyl acrylate).

In certain embodiments (embodiment 3), R of Formula (I) (other than t-butyl acrylate) of embodiment 1 or 2 has no more than 20 carbon atoms, no more than 16 carbon atoms, no more than 12 carbon atoms, no more than 10 carbon atoms, no more than 6 carbon atoms, or no more than 4 carbon atoms. In certain embodiments (embodiment 4), a paint of any of the previous embodiments is provided wherein R of Formula (I) (other than t-butyl acrylate) is a branched alkyl group having a tertiary carbon atom. In certain embodiments (embodiment 5), a paint of any of the previous embodiments is provided wherein R of Formula (I) (other than t-butyl acrylate) is a branched alkyl group of 4 to 10 carbon atoms having a tertiary carbon atom.

In certain embodiments (embodiment 6), a paint of any of the previous embodiments is provided wherein the monomer of Formula (I) (other than t-butyl acrylate) has a homopolymer Tg of less than 110° C. or less than 50° C. In certain embodiments (embodiment 7), a paint of any of the previous embodiments is provided wherein the monomer of Formula (I) (other than t-butyl acrylate) has a homopolymer Tg of at least 20° C., or at least 30° C.

In certain embodiments (embodiment 8), a paint of any of the previous embodiments is provided wherein the emulsion latex polymer comprises t-butyl acrylate and a mixture of monomers of Formula (I).

In certain embodiments (embodiment 9), a paint of any of the previous embodiments is provided wherein the one or more monomers of Formula (I) (other than t-butyl acrylate) are selected from isobornyl acrylate, cyclohexyl acrylate, and a mixture thereof.

In certain embodiments (embodiment 10), a paint of any of the previous embodiments is provided wherein the latex polymer has an acid number of up to 30 (mg KOH per gram sample). In certain embodiments (embodiment 11), a paint of any of the previous embodiments is provided wherein the latex polymer has an acid number of at least 5 (mg KOH per gram sample).

In certain embodiments (embodiment 12), a paint of any of the previous embodiments is provided wherein the latex polymer comprises latex particles having a volume average particle size of at least 50 nm, or at least 60 nm, or at least 70 nm. In certain embodiments (embodiment 13), a paint of any of the previous embodiments is provided wherein the latex polymer comprises latex particles having a volume average particle size of up to 150 nm, or up to 130 nm.

In certain embodiments (embodiment 14), a paint of any of the previous embodiments is provided comprising at least 15 wt-% of the emulsion latex polymer, based on the total nonvolatile weight of the paint. In certain embodiments (embodiment 15), a paint of any of the previous embodiments is provided comprising up to 50 wt-% of the emulsion latex polymer, based on the total nonvolatile weight of the paint. In certain embodiments (embodiment 16), a paint of embodiment 15 is provided comprising up to 30 wt-% of the emulsion latex polymer, based on the total nonvolatile weight of the paint.

In certain embodiments (embodiment 17), a paint of any of the previous embodiments is provided wherein the polymer is a two- or more-stage emulsion latex polymer (e.g., resulting from a power feed process). In certain embodiments (embodiment 18), a paint of embodiment 17 is provided wherein the t-butyl acrylate is present in a hard stage of the emulsion latex polymer.

In certain embodiments (embodiment 19), a paint of any of the previous embodiments is provided wherein the interpolymerized monomers comprise at least 2 wt-%, or at least 5 wt-%, of t-butyl acrylate and optionally one or more monomers of Formula (I), based on the total weight of the interpolymerized monomers. In certain embodiments (embodiment 20), a paint of any of the previous embodiments is provided wherein the interpolymerized monomers comprise less than 20 wt-% (or up to 15 wt-%, or up to 10 wt-%) of t-butyl acrylate and optionally one or more monomers of Formula (I), based on the total weight of the interpolymerized monomers.

In certain embodiments (embodiment 21), a paint of any of the previous embodiments is provided wherein the interpolymerized monomers comprise one or more (meth)acrylate monomers selected from n-butyl (meth)acrylate (n-BA and n-BMA), ethylhexyl (meth)acrylate, methyl (meth)acrylate, and combinations thereof. In certain embodiments (embodiment 22), a paint of any of the previous embodiments is provided wherein the interpolymerized monomers comprise at least 10 wt-% (or at least 20 wt-%, at least 30 wt-%, at least 40 wt-%, at least 50 wt-%, at least 60 wt-%, at least 70 wt-%, at least 75 wt-%, at least 80 wt-%, at least 83 wt-%, at least 84 wt-%, at least 85 wt-%, or at least 90 wt-%) of one or more (meth)acrylate monomers (e.g., two or more (meth)acrylate monomers), based on the total weight of the interpolymerized monomers. In certain embodiments (embodiment 23), a paint of any of the previous embodiments is provided wherein the interpolymerized monomers comprise up to 99 wt-% (or up to 98 wt-%, or up to 95 wt-%) of one or more (meth)acrylate monomers (e.g., two or more (meth)acrylate monomers), based on the total weight of the interpolymerized monomers.

In certain embodiments (embodiment 24), a paint of any of the previous embodiments is provided wherein the interpolymerized monomers comprise styrene. In certain embodiments (embodiment 25), a paint of any of the previous embodiments is provided wherein the interpolymerized monomers comprise at least 1 wt-% (or at least 5 wt-%, at least 10 wt-%, or at least 15 wt-%) styrene, based on the total weight of the interpolymerized monomers. In certain embodiments (embodiment 26), a paint of any of the previous embodiments is provided wherein the interpolymerized monomers comprise up to 75 wt-% (or up to 50 wt-%) styrene, based on the total weight of the interpolymerized monomers.

In certain embodiments (embodiment 27), a paint of any of the previous embodiments is provided wherein the interpolymerized monomers comprise one or more wet adhesion monomers (e.g., those selected from N-(2-methacryloyloxyethyl) ethylene urea, 1-(2-((3-(allyloxy)-2-hydroxypropyl)amino)ethyl)imidazolidine-2-one, and combinations thereof). In certain embodiments (embodiment 28), a paint of embodiment 27 is provided wherein the interpolymerized monomers comprise at least 0.2 wt-% of one or more wet adhesion monomers, based on the total weight of the interpolymerized monomers. In certain embodiments (embodiment 29), a paint of embodiment 27 or 28 is provided wherein the interpolymerized monomers comprise up to 2.0 wt-% (or up to 1.0 wt-%) of one or more wet adhesion monomers, based on the total weight of the interpolymerized monomers.

In certain embodiments (embodiment 30), a paint of any of the previous embodiments is provided which is a clear (i.e., unpigmented) paint.

In certain embodiments (embodiment 31), a paint of any of the previous embodiments is provided further comprising one or more additives selected from a surfactant, thickener, coalescent, biocide, mildewcide, colorant (e.g., inorganic pigment), and mixtures thereof. In certain embodiments (embodiment 32), a paint of embodiment 313 is provided comprising an inorganic pigment (e.g., CaCO₃, TiO₂). In certain embodiments (embodiment 33), a paint of embodiment 31 or 32 is provided comprising a thickener (e.g., to allow the polymer to coat out on a substrate surface). In certain embodiments (embodiment 34), a paint of any of the previous embodiments is provided comprising one or more additives for wet hide capability (e.g., titanium dioxide particles, opaque polymeric spheres, and kaolin clay platelets).

In certain embodiments (embodiment 35), a paint of any of the previous embodiments is provided having a viscosity of 60-120 units measured by Krebs Viscometer at room temperature (suitable for spray, roll, or brush).

In certain embodiments (embodiment 36), a paint of any of the previous embodiments is provided wherein a hardened coating formed from the paint has a stain-blocking performance, based on the Stain-blocking Test described in the Examples Section (based on ASTM D7514-14), when the paint is a semi-gloss paint, characterized by a ΔE value of: at most 7 for a red permanent marker (e.g., Sharpie Red); and/or at most 22 for a black water-washable marker (e.g., Marks a Lot Black); and/or at most 22 for a blue water-washable marker (e.g., Window Marker Blue); and/or at most 17 for a green water-washable marker (e.g., Window Marker Green); or a stain-blocking performance, based on the Stain-blocking Test described in the Examples Section (based on ASTM D7514-14), when the paint is a flat paint, characterized by a ΔE value of: at most 15 for a red permanent marker (e.g., Sharpie Red); and/or at most 19 for a black water-washable marker (e.g., Marks a Lot Black); and/or at most 18 for a blue water-washable marker (e.g., Window Marker Blue); and/or at most 17 for a green water-washable marker (e.g., Window Marker Green).

In certain embodiments (embodiment 37), a paint of any of the previous embodiments is provided wherein a hardened coating formed from the paint has an adhesion performance of at least 2 (whether for a wet or dry adhesion test, preferably, for a dry adhesion test, when the paint is a flat paint or a semi-gloss paint) based on the ASTM 3359-23 Cross-cut Adhesion Test. In certain embodiments (embodiment 38), a paint of any of the previous embodiments is provided wherein a scrub resistance of at least 600, or at least 800, or at least 1000 cycles (whether the paint is a flat paint or a semi-gloss paint) based on ASTM 2486-17 Scrub Resistance Test.

In certain embodiments (embodiment 39), a paint of any of the previous embodiments is provided which is a low VOC paint (i.e., contains less than 10 wt-% volatile organic compounds, based on the total weight of the paint). In certain embodiments (embodiment 40), a paint of embodiment 39 is provided which includes less than 7 wt-%, or less than 4 wt-%, volatile organic compounds, based on the total weight of the paint).

In certain embodiments (embodiment 41), the stain-blocking paint of any of the previous embodiments is a stain-blocking topcoat paint.

In certain embodiments (embodiment 42), the stain-blocking paint of any of the previous embodiments is a paint-and-primer-in-one paint composition.

In certain embodiments (embodiment 43), a stain-blocking paint is provided that includes: an emulsion latex polymer comprising interpolymerized monomers comprising: at least 1 wt-% of t-butyl acrylate and optionally one or more acrylic acid ester monomers of Formula (I) (other than t-butyl acrylate):

RO—C(O)—CH═CH₂

wherein: R is a branched alkyl having a tertiary carbon atom; at least 10 wt-% of one or more (meth)acrylate monomers selected from n-butyl (meth)acrylate, ethylhexyl (meth)acrylate, methyl (meth)acrylate, and combinations thereof; and at least 1 wt-% styrene; wherein the weight percentages are based on the total weight of the interpolymerized monomers.

In certain embodiments (embodiment 44), a hardened coating formed from the stain-blocking paint of embodiment 43 has one or more of the following properties: a stain-blocking performance, based on the Stain-blocking Test described in the Examples Section (based on ASTM D7514-14), when the paint is a semi-gloss paint, characterized by a ΔE value of: at most 7 for a red permanent marker (e.g., Sharpie Red); and/or at most 22 for a black water-washable marker (e.g., Marks a Lot Black); and/or at most 22 for a blue water-washable marker (e.g., Window Marker Blue); and/or at most 17 for a green water-washable marker (e.g., Window Marker Green); a stain-blocking performance, based on the Stain-blocking Test described in the Examples Section (based on ASTM D7514-14), when the paint is a flat paint, characterized by a ΔE value of: at most 15 for a red permanent marker (e.g., Sharpie Red); and/or at most 19 for a black water-washable marker (e.g., Marks a Lot Black); and/or at most 18 for a blue water-washable marker (e.g., Window Marker Blue); and/or at most 17 for a green water-washable marker (e.g., Window Marker Green); an adhesion performance of at least 2 (whether for a wet or dry adhesion test, preferably, for a dry adhesion test, when the paint is a flat paint or a semi-gloss paint) based on the ASTM 3359-23 Cross-cut Adhesion Test; and a scrub resistance of at least 600, or at least 800, or at least 1000 cycles (whether the paint is a flat paint or a semi-gloss paint) based on ASTM 2486-17 Scrub Resistance Test.

In certain embodiments (embodiment 45), a paint of embodiment 43 or 44 is provided that includes an emulsion latex polymer comprising interpolymerized monomers comprising: at least 1 wt-%, based on total weight of monomers, of t-butyl acrylate and one or more acrylic acid ester monomers of Formula (I) (other than t-butyl acrylate).

In certain embodiments (embodiment 46), a stain-blocking paint of embodiment 45 is provided wherein R of Formula (I) (other than t-butyl acrylate) has no more than 20 carbon atoms, no more than 16 carbon atoms, no more than 12 carbon atoms, no more than 10 carbon atoms, no more than 6 carbon atoms, or no more than 4 carbon atoms. In certain embodiments (embodiment 47), a stain-blocking paint of embodiment 45 or 46 is provided wherein R of Formula (I) (other than t-butyl acrylate) is a branched alkyl group having a tertiary carbon atom. In certain embodiments (embodiment 48), a stain-blocking paint of embodiments 45 through 47 is provided wherein R of Formula (I) (other than t-butyl acrylate) is a branched alkyl group of 4 to 10 carbon atoms having a tertiary carbon atom. In certain embodiments (embodiment 49), a stain-blocking paint of embodiments 45 through 48 is provided wherein the monomer of Formula (I) (other than t-butyl acrylate) has a homopolymer Tg of less than 110° C., or less than 50° C. In certain embodiments (embodiment 50), a stain-blocking paint of embodiments 45 through 49 is provided wherein the monomer of Formula (I) (other than t-butyl acrylate) has a homopolymer Tg of at least 20° C., or at least 30° C.

In certain embodiments (embodiment 51), a stain-blocking paint of embodiments 45 through 50 is provided wherein the emulsion latex polymer comprises a mixture of monomers of Formula (I).

In certain embodiments (embodiment 52), a stain-blocking polymer of embodiments 45 through 51 is provided wherein the one or more monomers of Formula (I) (other than t-butyl acrylate) are selected from isobornyl acrylate, cyclohexyl acrylate, and a mixture thereof.

In certain embodiments (embodiment 53), a stain-blocking paint of embodiments 43 through 52 is provided wherein the latex polymer has an acid number of up to 30 (mg KOH per gram sample). In certain embodiments (embodiment 54), a stain-blocking paint of embodiments 43 through 53 is provided wherein the latex polymer has an acid number of at least 5 (mg KOH per gram sample).

In certain embodiments (embodiment 55), a stain-blocking paint of embodiments 43 through 54 is provided wherein the latex polymer comprises latex particles having a volume average particle size of at least 50 nm, or at least 60 nm, or at least 70 nm. In certain embodiments (embodiment 56), a stain-blocking paint of embodiments 43 through 55 is provided wherein the latex polymer comprises latex particles having a volume average particle size of up to 150 nm, or up to 130 nm.

In certain embodiments (embodiment 57), a stain-blocking paint of embodiments 43 through 56 is provided wherein the polymer is a two- or more-stage emulsion latex polymer (e.g., resulting from a power feed process). In certain embodiments (embodiment 58), a stain-blocking paint of embodiment 57 is provided wherein the t-butyl acrylate is present in a hard stage of the emulsion latex polymer.

In certain embodiments (embodiment 59), a stain-blocking paint of embodiments 43 through 58 is provided wherein the interpolymerized monomers comprise at least 2 wt-%, or at least 5 wt-%, of t-butyl acrylate and optionally one or more monomers of Formula (I), based on the total weight of the interpolymerized monomers. In certain embodiments (embodiment 60), a stain-blocking paint of embodiments 43 through 59 is provided wherein the interpolymerized monomers comprise less than 20 wt-% (or up to 15 wt-%, or up to 10 wt-%) of t-butyal acrylate and optionally one or more monomers of Formula (I), based on the total weight of the interpolymerized monomers.

In certain embodiments (embodiment 61), a stain-blocking paint of embodiments 43 through 60 is provided wherein the interpolymerized monomers comprise at least 75 wt-% (or least 80 wt-%, at least 83 wt-%, at least 84 wt-%, at least 85 wt-%, or at least 90 wt-%) of one or more (meth)acrylate monomers (e.g., two or more (meth)acrylate monomers) selected from n-butyl (meth)acrylate, ethylhexyl (meth)acrylate, methyl (meth)acrylate, and combinations thereof, based on the total weight of the interpolymerized monomers. In certain embodiments (embodiment 62), a stain-blocking paint of embodiments 43 through 61 is provided wherein the interpolymerized monomers comprise up to 99 wt-% (or up to 98 wt-%, or up to 95 wt-%) of one or more (meth)acrylate monomers (e.g., two or more (meth)acrylate monomers) selected from n-butyl (meth)acrylate, ethylhexyl (meth)acrylate, methyl (meth)acrylate, and combinations thereof, based on the total weight of the interpolymerized monomers.

In certain embodiments (embodiment 63), a stain-blocking paint of embodiments 43 through 62 is provided wherein the interpolymerized monomers comprise at least 5 wt-% (or at least 10 wt-%, or at least 15 wt-%) styrene, based on the total weight of the interpolymerized monomers. In certain embodiments (embodiment 64), a stain-blocking paint of embodiments 43 through 63 is provided wherein the interpolymerized monomers comprise up to 75 wt-% (or up to 50 wt-%) styrene, based on the total weight of the interpolymerized monomers.

In certain embodiments (embodiment 65), a stain-blocking paint of embodiments 43 through 64 is provided wherein the interpolymerized monomers comprise one or more wet adhesion monomers (e.g., those selected from N-(2-methacryloyloxyethyl) ethylene urea, 1-(2-((3-(allyloxy)-2-hydroxypropyl)amino)ethyl)imidazolidine-2-one, and combinations thereof). In certain embodiments (embodiment 66), a stain-blocking paint of embodiments 43 through 65 is provided wherein the interpolymerized monomers comprise at least 0.2 wt-% of one or more wet adhesion monomers, based on the total weight of the interpolymerized monomers. In certain embodiments (embodiment 67), a stain-blocking paint of embodiment 65 or 66 is provided wherein the interpolymerized monomers comprise up to 2.0 wt-% (or up to 1.0 wt-%) of one or more wet adhesion monomers, based on the total weight of the interpolymerized monomers.

In certain embodiments (embodiment 68), the stain-blocking paint of embodiments 43 through 67 is a stain-blocking topcoat paint.

In certain embodiments (embodiment 69), the stain-blocking paint of embodiments 43 through 68 is a paint-and-primer-in-one paint composition.

In certain embodiments (embodiment 70), a stained substrate is provided having a stain-blocking paint of any of the previous embodiments coated thereon.

In certain embodiments (embodiment 71), a kit for making a stain-blocking paint of embodiments 1 through 69 is provided that includes: an emulsion latex polymer comprising interpolymerized monomers comprising: at least 1 wt-%, based on the total weight of the interpolymerized monomers, of t-butyl acrylate and optionally one or more acrylic acid ester monomers of Formula (I) (other than t-butyl acrylate):

RO—C(O)—CH═CH₂

wherein: R is a branched alkyl having a tertiary carbon atom, a cycloaliphatic group, or a combination thereof; optionally, one or more (meth)acrylate monomers selected from n-butyl (meth)acrylate, ethylhexyl (meth)acrylate, methyl (meth)acrylate, and combinations thereof; optionally, one or more wet adhesion monomers; and optionally, styrene; and instructions for forming a stain-blocking paint from the polymer.

In certain embodiments (embodiment 72), a kit for making a stain-blocking paint of embodiment 71 is provided wherein a hardened coating formed from the paint has a stain-blocking performance, based on the Stain-blocking Test described in the Examples Section (based on ASTM D7514-14), when the paint is a semi-gloss paint, characterized by a ΔE value of: at most 7 for a red permanent marker (e.g., Sharpie Red); and/or at most 22 for a black water-washable marker (e.g., Marks a Lot Black); and/or at most 22 for a blue water-washable marker (e.g., Window Marker Blue); and/or at most 17 for a green water-washable marker (e.g., Window Marker Green); or a stain-blocking performance, based on the Stain-blocking Test described in the Examples Section (based on ASTM D7514-14), when the paint is a flat paint, characterized by a ΔE value of: at most 15 for a red permanent marker (e.g., Sharpie Red); and/or at most 19 for a black water-washable marker (e.g., Marks a Lot Black); and/or at most 18 for a blue water-washable marker (e.g., Window Marker Blue); and/or at most 17 for a green water-washable marker (e.g., Window Marker Green).

In certain embodiments (embodiment 73), a kit for making a stain-blocking paint of embodiment 71 or 72 is provided wherein the emulsion latex polymer and the instructions are physically packaged together (but the two don't need to be physically delivered together in a physical package to be a kit).

In certain embodiments (embodiment 74), a method is provided that includes: causing a stain-blocking paint of embodiments 1 through 69 to be applied to a stained substrate.

In certain embodiments (embodiment 75), a method is provided that includes: causing a stain-blocking paint to be applied to a stained substrate, the stain-blocking paint comprising an emulsion latex polymer comprising interpolymerized monomers comprising: at least 1 wt-% to less than 20 wt-%, based on the total weight of the interpolymerized monomers, of t-butyl acrylate; optionally, one or more (meth)acrylate monomers selected from n-butyl (meth)acrylate, ethylhexyl (meth)acrylate, methyl (meth)acrylate, and combinations thereof; optionally, one or more wet adhesion monomers; and optionally, styrene.

### EXAMPLES

These Examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Missouri, or may be synthesized by conventional methods. The following abbreviations may be used in the following examples: ppm=parts per million; phr=parts per hundred rubber; mL=milliliter; L=liter; m=meter, mm=millimeter, cm=centimeter, kg=kilogram, g=gram, min=minute, s=second, hrs=hour, ° C.=degrees Celsius, ° F.=degrees Fahrenheit, MPa=megapascals, and N-m=Newton-meter, Mn=number average molecular weight, cP=centipoise.

### Theoretical Fox Tg Calculation

The Glass Transition Temperature (Tg) of the disclosed polymer composition is predicted from the Fox Equation, a generalized form of which is shown below:

$$Tg = {( \frac{{W}_{A}}{{Tg}_{A}} + \frac{{W}_{B}}{T {g}_{B}} + \frac{{W}_{C}}{{Tg}_{C}} + … + \frac{{W}_{N}}{T {g}_{N}} )}^{- 1} ,$$

where W_{A}, W_{B}, W_{C}, . . . , W_{N} respectively represent the weight fraction of each monomer type A, B, C, . . . , N in the copolymer composition, and Tg_{A}, Tg_{B}, Tg_{C}, . . . , Tg_{N} represent the corresponding Tg's (expressed in Kelvin) of the homopolymers prepared from the respective monomer type A, B, C, . . . , N. For example, a polymer composition consisting of 55.8 wt-% styrene (Tg, styrene=373.15K), 42.8 wt-% 2-ethylhexyl acrylate (Tg, 2-EHA=193.15 K), and 1.4 wt-% methacrylic acid (Tg, MAA=458.15) will have a predicted Fox Tg of

$$Tg = {[ \frac{0.558}{373.15 K} + \frac{0.428}{193.15 K} + \frac{0.014}{458.15 K} ]}^{- 1} = 267.25 K ,$$

or equivalently, −5.9° C.

The Fox equation is also known to adequately predict the effective overall Tg of a miscible polymer mixture. In the case of a multi-stage polymer blend, the overall Tg of the polymer blend can be determined by applying the Tg and weight fraction of each polymer stage in the Fox equation.

### Actual Tg

The actual Tg of a polymer or polymer blend can determined experimentally by techniques such as differential scanning calorimetry (DSC) and dynamic mechanical analysis (DMA). All actual Tg disclosed in the current disclosure are evaluated using a DSC25 differential scanning calorimeter equipped with a RCS90 cooler, both purchased from TA Instruments. Calibration was performed on an indium standard and all experiments use a standardized heat-cool-heat cycle at a 20° C./min ramp rate.

### Latex Examples

Various latex samples were prepared and the properties of the samples were tested using a Stain-blocking Test, Adhesion Test, and Scrub Resistance Test.

All latex examples were synthesized under starved fed condition to reduce chances of block copolymerization. Some of resulting latexes surprisingly produce coatings that demonstrate noticeably improved stain-blocking compared to that of the comparative example latex. The example latexes and their corresponding comparative examples are adjusted to achieve the comparable ranges of minimum film formation temperature (MFFT) with the upper and lower range values showing variance of about ±1° C. The MFFT measurements were obtained on an MFFT-90 instrument (available from Rhopoint Americas in Troy, MI).

### Latex Preparation Procedure A—Single-Stage Acrylic Latex

To a 3-liter (3-L) reactor, a 30±5 nm, 30 wt-% seed latex (100 grams (g)) and deionized water (410 g) were added. The reactor was fitted with a four-blade impeller, a condenser, and an internal temperature probe. The reactor assembly was heated to an internal temperature of 58-60° C. with constant agitation maintained throughout the synthetic process. In a separate 0.8 L container, monomer emulsion was prepared by sequentially adding deionized water (294 g), DISPONIL FES 32 (50 g), SIPOMER PAM-4000 (2 g), VISIOMER MEEU 25M (20 g), methacrylic acid (12 g), 28% ammonium hydroxide (3 g), and a mixture of monomers (TABLE 1) under constant mixing with a three-blade impeller. Prior to addition of monomer emulsion to reactor, 70% aqueous tert-butyl hydroperoxide (0.8 g), erythorbic acid (0.5 g), and 7% aqueous DISSOLVINE E-FE-13 (0.2 g) were added to the reactor. Monomer emulsion was fed into the reactor over 3 hours (hr). Upon initiation of monomer emulsion feed, an oxidizer solution containing 70% aqueous tert-butyl hydroperoxide (4.7 g) in deionized water (65 g) and a reducer solution containing erythorbic acid (2.8 g) in deionized water (65 g) were fed separately and simultaneously into the reactor over 4 hr. At the end of oxidizer and reducer feeds, the reactor solution was cooled to below 40° C. and neutralized with 28% ammonium hydroxide (5 g). The resulting emulsion was diluted with deionized water (99 g) and filtered through a 100 μm filter.

TABLE 1
Components.

| | Monomer Mixture (g) | | | | |
|---|---|---|---|---|---|
| Example Number | BA | 2-EHA | MMA | tBA | MFFT (° C.) |
| Example 1 | 443 | 30 | 390 | 100 | 8-15 |
| Example 2 | 490 | 30 | 443 | — | 7-15 |
| (Comparative) | | | | | |

### Latex Preparation Procedure B—Single-Stage Styrene-Acrylic Latex

To a 3-liter (3-L) reactor, a 30±5 nm, 30 wt-% seed latex (100 grams (g)) and deionized water (410 g) were added. The reactor was fitted with a four-blade impeller, a condenser, and an internal temperature probe. The reactor assembly was heated to an internal temperature of 58-60° C. with constant agitation maintained throughout the synthetic process. In a separate 0.8 L container, monomer emulsion was prepared by sequentially adding deionized water (294 g), DISPONIL FES 32 (50 g), SIPOMER PAM-4000 (5 g), VISIOMER MEEU 25M (20 g), methacrylic acid (12 g), 28% ammonium hydroxide (4 g), and a mixture of monomers (TABLE 2) under constant mixing with a three-blade impeller. Prior to addition of monomer emulsion to reactor, 70% aqueous tert-butyl hydroperoxide (0.8 g), erythorbic acid (0.5 g), and 7% aqueous DISSOLVINE E-FE-13 (0.2 g) were added to the reactor. Monomer emulsion was fed into the reactor over 3 hours (hr). Upon initiation of monomer emulsion feed, an oxidizer solution containing 70% aqueous tert-butyl hydroperoxide (4.7 g) in deionized water (65 g) and a reducer solution containing erythorbic acid (2.8 g) in deionized water (65 g) were fed separately and simultaneously into the reactor over 4 hr. At the end of oxidizer and reducer feeds, the reactor solution was cooled to below 40° C. and neutralized with 28% ammonium hydroxide (6 g). The resulting emulsion was diluted with deionized water (99 g) and filtered through a 100 μm filter.

TABLE 2
Components.

| | Monomer Mixture (g) | | | | |
|---|---|---|---|---|---|
| Example Number | BA | 2-EHA | Styrene | tBA | MFFT (° C.) |
| Example 3 | 443 | 30 | 390 | 100 | 12-15 |
| Example 4 | 490 | 30 | 443 | — | 11-14 |
| (Comparative) | | | | | |

### Latex Preparation Procedure C—Two-Stage Acrylic Latex

To a 3-liter (3-L) reactor, a 30±5 nm, 30 wt-% seed latex (104 grams (g)) and deionized water (490 g) were added. The reactor was fitted with a four-blade impeller, a condenser, and an internal temperature probe. The reactor assembly was heated to an internal temperature of 58-60° C., with constant agitation maintained throughout the synthetic process. In a separate 0.8 L container, monomer emulsion 1 was prepared by sequentially adding deionized water (110 g), DISPONIL FES 32 (18 g), SIPOMER PAM-4000 (5 g), diacetone acrylamide (5 g), VISIOMER MEEU 25M (6 g), methacrylic acid (4 g), 28% ammonium hydroxide (1.5 g), and a mixture of monomers (TABLE 3) under constant mixing with a three-blade impeller. In a separate 1.8 L container, monomer emulsion 2 was prepared by sequentially adding deionized water (200 g), DISPONIL FES 32 (35 g), SIPOMER PAM-4000 (9 g), diacetone acrylamide (10 g), VISIOMER MEEU 25M (12 g), methacrylic acid (8 g), 28% ammonium hydroxide (3 g), 2-ethylhexyl acrylate (2-EHA) (21 g), n-butyl acrylate (BA) (350 g), and methyl methacrylate (MMA) (279 g) under constant mixing with a three-blade agitator. Prior to addition of monomer emulsion 1 to reactor, 70% aqueous tert-butyl hydroperoxide (0.8 g), erythorbic acid (0.5 g) dissolved in deionized water (9.5 g), and 7% aqueous DISSOLVINE E-FE-13 (0.2 g) were added to the reactor. Monomer emulsion 1 was fed into the reactor over 1 hour (hr). Upon initiation of monomer emulsion 1 feed, an oxidizer solution containing 70% aqueous tert-butyl hydroperoxide (5 g) in deionized water (65 g) and a reducer solution containing erythorbic acid (3 g) in deionized water (65 g) were fed separately and simultaneously into the reactor over 4 hr. Upon depletion of monomer emulsion 1, monomer emulsion 2 was fed into the reactor over 2 hr. At the end of oxidizer and reducer feeds, the reactor solution was cooled to below 40° C. and neutralized with 28% ammonium hydroxide (6 g) to pH >8. Adipic dihydrazide (4.5 g) was to the reactor and mix for 15 min. The resulting emulsion was diluted with deionized water (125 g) and filtered through a 100 μm filter.

TABLE 3
Components.

| | Monomer Mixture (g) | | | | |
|---|---|---|---|---|---|
| Example Number | BA | 2-EHA | MMA | tBA | MFFT (° C.) |
| Example 5 | 26 | 11 | 193 | 105 | 20-23 |
| Example 6 (Comparative) | 74 | 11 | 250 | — | 20-22 |

### Latex Preparation Procedure D—Two-Stage Styrene-Acrylic Latex

To a 3-liter (3-L) reactor, a 30±5 nm, 30 wt-% seed latex (104 grams (g)) and deionized water (490 g) were added. The reactor was fitted with a four-blade impeller, a condenser, and an internal temperature probe. The reactor assembly was heated to an internal temperature of 58-60° C. with constant agitation maintained throughout the synthetic process. In a separate 0.8 L container, monomer emulsion 1 was prepared by sequentially adding deionized water (110 g), DISPONIL FES 32 (18 g), SIPOMER PAM-4000 (5 g), VISIOMER MEEU 25M (6 g), methacrylic acid (4 g), 28% ammonium hydroxide (2 g), dodecyl mercaptan (0.1 g), and a mixture of monomers (TABLE 4) under constant mixing with a three-blade impeller. In a separate 1.8 L container, monomer emulsion 2 was prepared by sequentially adding deionized water (200 g), DISPONIL FES 32 (35 g), SIPOMER PAM-4000 (9 g), VISIOMER MEEU 25M (12 g), methacrylic acid (8 g), 28% ammonium hydroxide (2 g), dodecyl mercaptan (0.2 g), 2-ethylhexyl acrylate (2-EHA) (340 g), and styrene (310 g) under constant mixing with a three-blade agitator. Prior to addition of monomer emulsion 1 to reactor, 70% aqueous tert-butyl hydroperoxide (0.8 g), erythorbic acid (0.5 g) dissolved in deionized water (9.5 g), and 7% aqueous DISSOLVINE E-FE-13 (0.2 g) were added to the reactor. Monomer emulsion 1 was fed into the reactor over 1 hour (hr). Upon initiation of monomer emulsion 1 feed, an oxidizer solution containing 70% aqueous tert-butyl hydroperoxide (5 g) in deionized water (65 g) and a reducer solution containing erythorbic acid (3 g) in deionized water (65 g) were fed separately and simultaneously into the reactor over 4 hr. Upon depletion of monomer emulsion 1, monomer emulsion 2 was fed into the reactor over 2 hr. At the end of oxidizer and reducer feeds, the reactor solution was cooled to below 40° C. and neutralized with 28% ammonium hydroxide (6 g). The resulting emulsion was diluted with deionized water (125 g) and filtered through a 100 μm filter.

TABLE 4
Components.

| | Monomer Mixture (g) | | | |
|---|---|---|---|---|
| Example Number | 2-EHA | Styrene | tBA | MFFT (° C.) |
| Example 7 | 15 | 230 | 105 | 23 |
| Example 8 (Comparative) | 50 | 300 | — | 23 |

TABLE 5
MATERIALS

| Material Name | Ingredient of Property (Function) | Source |
|---|---|---|
| DI Water | De-ionized water (Continuous Phase) | MilliporeSigma in |
| | | Burlington, MA |
| Seed Latex | A styrene acrylate polymer with a solids | |
| | content of 30 wt-% and particle size of 35 nm | |
| | made by emulsion polymerization with an | |
| | anionic surfactant (Seed Polymer) | |
| DISPONIL FES 32 | Fatty alcohol ether sulphate, sodium salt | BASF Corporation in |
| | (Emulsifier/Surfactant) | Florham Park, NJ |
| Methacrylic Acid | T_{g} = 185° C. (Monomer) | MilliporeSigma |
| Styrene | T_{g} = 100° C. (Monomer) | MilliporeSigma |
| t-Butyl Acrylate | T_{g} = 44° C. (Monomer) | BASF Corporation |
| (“tBA”) | | |
| t-Butyl | T_{g} = 117° C. (Monomer) | BASF Corporation |
| Methacryalte | | |
| (“tBMA”) | | |
| 2-Ethylhexyl | T_{g} = −85° C. (Monomer) | MilliporeSigma |
| Acrylate (“EHA”) | | |
| Cyclohexyl | T_{g} = 19° C.; ≥98% by GC (Monomer) | TCI America in |
| Acrylate (“CHA”) | | Portland, OR |
| VISIOMER MEEU | N-(2-Methacryloyloxyethyl) ethylene urea, 25 | Evonik Industries |
| 25M | wt-% in methyl methacrylate (Monomer) | AG, Parsippany, NJ |
| Diacetone | T_{g} = 65° C. (Monomer) | KH Neochem Co., |
| Acrylamide | | Ltd. (USA) in |
| | | Schaumburg, IL |
| Iso-Butyl Acrylate | T_{g} = −24° C. (Monomer) | BASF Corporation |
| (“i-BuA”) | | |
| Iso-Bornyl Acrylate | T_{g} = 94° C.; ≥90% by GC (Monomer) | TCI America |
| (“i-BnA”) | | |
| t-Butyl | Initiator (Oxidizer) | United Initiators in |
| Hydroperoxide | | Pullach, Germany |
| Erythorbic Acid | Initiator (Reducer) | MilliporeSigma |
| SIPOMER PAM | Phosphoric acid 2-hydroxyethyl methacrylate | Solvay in Alpharetta, |
| 4000 | ether, T_{g} = 55° C. (Monomer) | Georgia |
| DISSOLVINE E- | Ethylenediaminetetraacetic acid ferric-sodium | Akzo Nobel in |
| FE-13 | complex (Catalyst) | Chicago, IL |
| 7 wt-% aqueous | | |
| solution | | |
| n-Dodecyl | (Chain Transfer Agent) | MilliporeSigma |
| Mercaptan | | |
| Ammonium | 26 Degree Baumé, 29 wt-% active ammonia | Viking Chemical |
| hydroxide | (Volatile Base) | Company in |
| | | Rockford, IL |
| NUOSEPT 498 | 1,2-benzisothiazolin-3-one aqueous dispersion | Troy Corporation in |
| | (Biocide) | Florham Park, NJ |
| AQUAFLOW | Hydrophobically modified polyether, 20 wt-% | Ashland Inc. in |
| NHS-310 | aqueous dispersion (Non-ionic associative | Covington, KY |
| | Thickener) | |
| ACRYSOL RM- | Hydrophobically modified ethylene oxide | Dow Chemical in |
| 8W | urethane, 18 wt-% aqueous dispersion (Non- | Midland, MI |
| | ionic Thickener) | |
| EPS 9147 | (Low VOC Coalescent; proprietary | Engineered Polymer |
| | composition) | Solutions in |
| | | Marengo, IL |
| TEXANOL | 2,2,4-trimethyl-1,3-pentanediol | Eastman Chemical |
| | monoisobutyrate >99%; 2,2,4-trimethyl-1,3- | Company, Kingsport, |
| | pentanediol diisobutyrate ≤0.8% | TN |
| TAMOL 165A | Ammonium salts of polycarboxylates | Dow Chemical |
| | (Hydrophobic Copolymer Dispersant) | |
| DREWPLUS L- | Distillates (petroleum), solvent-dewaxed heavy | Ashland Inc. |
| 475 | paraffinic; CAS#: 64742-65-0 (Defoamer) | |
| STRODEX NB-20 | Mixture of alkyl phenol ethers: | Ashland Inc. |
| | Polyoxyethylene octyl phenyl ether (95 wt-%), | |
| | Poly(oxy-1,2-ethanediyl), alpha- | |
| | (nonylphenyl)-omega-hydroxy-, branched, | |
| | phosphates, sodium salts (2.9 wt-%), | |
| | nonylphenol branched polyethoxylate (1.7 wt- | |
| | %). (Surfactant) | |
| AMP-95 | 2-amino-2-methyl-1-propanol containing 5 wt- | ANGUS Chemical in |
| | % added water (Base) | Buffalo Grove, IL |
| CAMEL-WHITE | Calcium carbonate (Pigment) | Imerys Carbonates in |
| | | Paris, France |
| SURFYNOL 104A | 2,4,7,9-Tetramethyldec-5-yne-4,7-diol, 50 wt- | Evonik AG |
| | % solution in 2-Ethylhexan-1-ol | |
| | (Surfactant/Dispersant) | |
| KRONOS 4311 | Rutile titanium dioxide slurry, 77 wt-% solids | Kronos Worldwide, |
| | (Pigment) | Inc. in Dallas, TX |
| MINEX 4 | Micronized nepheline syenite, median | Unimin Corporation |
| | diameter 6.8 μm (Filler/extender) | in New Canaan, CT |
| DIAFIL 525 | Natural diatomite powder, median particle size | Imerys |
| | 12 μm (Matting Agent) | |
| ATTAGEL 50 | Micronized attapulgite powder, average | BASF Corporation |
| | particle size 0.1 μm. (Rheology Modifier) | |
| Sodium Nitrite | 4 wt-% dissolved in DI water (Corrosion | MilliporeSigma |
| | Inhibitor) | |
| OPTIFLO L1400 | 20 wt-% in water (Associative HEUR | BYK in Wallingford, |
| | Thickener) | CT |
| RHEOBYK T- | Solution of a polyurethane, HEUR associative | BYK |
| 1000VF | thickener | |
| ACRYSOL RM- | HEUR rheology modifier, non-ionic, 25 wt-% | DOW Chemical |
| 825 | aqueous copolymer | |
| TAMOL 731 | Hydrophobic copolymer polyelectrolyte, 25 | DOW Chemical |
| | wt-% | |
| BYK 028 | Compound of modified polysiloxanes, | BYK |
| | polyether and hydrophobic particles | |
| MINEX 10 | Micronized functional filler and/or extender | Sibelco |
| | produced from nepheline syenite | |
| POLYPHASE 663 | 9% Methyl 2-benzimidazolecarbamate, | Troy |
| | 3% 3-Iodo-2-propynyl butyl carbamate, | |
| | 15% Diuron [3-(3,4-dichlorphenyl)-1,1- | |
| | dimethylurea) | |

### Examples 1, 3, 5, 7 and Comparative Examples 2, 4, 6, 8

Examples 1-2 were prepared according to the Latex Preparation Procedure A, using the Example 1-2 components as indicated in TABLE 1 above. Examples 3-4 were prepared according to the Latex Preparation Procedure B, using the Example 3-4 components as indicated in TABLE 2 above. Examples 5-6 were prepared according to the Latex Preparation Procedure C, using the Example 5-6 components as indicated in TABLE 3 above. Examples 7-8 were prepared according to the Latex Preparation Procedure D, using the Example 7-8 components as indicated in TABLE 4 above.

### Example Paint Formulation—Flat

This flat paint formulation was prepared for use in the Stain-blocking Test (data in TABLE 9, Adhesion Test (data in TABLE 10), and Scrub Resistance Test (data in TABLE 11). A pigment grind was prepared to add to example latex while stirring. The pigment grind was prepared by sequentially adding the following raw materials under constant mixing to maintain a vortex, 75 g of water, 5 g of TAMOL 731, 1.5 g of SURFYNOL 104A, 1.5 g of BYK 028, 0.25 g of KTPP, 1.5 g of ATTAGEL 50, 1.5 g of NUOSEPT 498, 163.4 g of KRONOS 4311, 57.5 g of MINEX 4, and 20 g of DIAFIL 525.

The pigment grind was added to 269 g of example latex stirring in a pint size can. The mixture was agitated for a suitable time, around 10 to 20 minutes. To this mixture, the let down ingredients were added in sequential order, 0.5 g of ammonium hydroxide, 5 g of 4% aqueous sodium nitrite, 5.4 g of EPS 9147, 7 g of RHEOBYK T-1000VF, and 1 g of ACRYSOL RM-825.

The amounts of the coalescent and rheology modifiers, EPS 9147 coalescent and RM-825, were adjusted for each example latex to achieve coalescence below 50° F. and a KU viscosity range of 100±20. TABLE 6 below contains the amounts used.

TABLE 6
Coalescent and Rheology Modifiers

| Flat Paint (FP) Example | EPS 9147 | ACRYSOL RM-825 |
|---|---|---|
| FP Example 1 | 5.4 | 0.6 |
| FP Example 2 (Comparative) | 5.4 | 1 |
| FP Example 3 | 13.4 | 0.4 |
| FP Example 4 (Comparative) | 13.4 | 0.3 |
| FP Example 5 | 14.8 | 1.6 |
| FP Example 6 (Comparative) | 14.8 | 0.9 |
| FP Example 7 | 14.8 | 0.7 |
| FP Example 8 (Comparative) | 13.4 | 0.5 |

### Example Paint Formulation—Semi-Gloss

A pigment grind was prepared to add to example latex while stirring. The pigment grind was prepared by sequentially adding the following raw materials under constant mixing to maintain a vortex, 25 g of water, 4 g of TAMOL 731, 1 g of SURFYNOL 104A, 1.5 g of BYK 028, 1.5 g of ATTAGEL 50, 1.5 g of NUOSEPT 498, 5 g of MINEX 10, and 168.5 g of KRONOS 4311.

The pigment grind was added to 269 g of polymer stirring in a pint size can. The mixture was agitated for a suitable time, around 10 to 20 minutes. To this mixture, the letdown ingredients were added in sequential order, 0.5 g of ammonium hydroxide, 5 g of 4% aqueous sodium nitrite, 5.4 g of EPS 9147, 2.5 g of POLYPHASE 663, 36 g of water, 4 g of RHEOBYK T-1000VF and 0.5 g of ACRYSOL RM-825.

The amounts of the coalescent and rheology modifiers, EPS 9147 coalescent and RM-825, were adjusted for each example latex to achieve coalescence below 50° F. and a KU viscosity range of 100±20. TABLE 7 below contains the amounts used.

TABLE 7
Coalescent and Rheology Modifier in Semi-Gloss Paints

| Semi-Gloss Paint (SGP) Example | EPS 9147 | ACRYSOL RM-825 |
|---|---|---|
| SGP Example 1 | 5.4 | 0.7 |
| SG Example 2 (Comparative) | 5.4 | 0.6 |
| SGP Example 3 | 13.4 | 2.1 |
| SGP Example 4 (Comparative) | 13.4 | 3.4 |
| SGP Example 5 | 14.8 | 1.1 |
| SGP Example 6 (Comparative) | 14.8 | 0.8 |
| SGP Example 7 | 14.8 | 0.4 |
| SGP Example 8 (Comparative) | 13.4 | 0.5 |

### Flat Basecoat Paint Formulation

This flat paint formulation was prepared for use in the Stain-blocking Test (to form a dry paint surface for applying the marker stains and for standardizing the spectrophotometer for colorimetric measurements). A pigment grind was added to a stirring EPS 2741 latex, followed by the addition of let down ingredients. The pigment grind was prepared by sequentially adding, in the order listed and under constant mixing with a Cowles blade to maintain a vortex, 50 g of water, 4 g of TAMOL 731, 1 g of SURFYNOL 104A, 1 g of DREWPLUS L-475, 1.5 g of NUOSEPT 498, 0.5 g of KTPP, 112.5 g of R-706, 100 g of MINEX 4, and 12.5 g of DIAFIL 525.

The grind was added to 200 g of EPS 2741 stirring in a pint-size can and the mixture was agitated for a suitable time, around 10-20 minutes. Let down ingredients were added, sequentially in the order listed, to the pigmented EPS 2741 latex: 0.5 g of ammonium hydroxide, 5 g of POLYPHASE 663, 11 g of EPS 9147, 1 g of DREWPLUS L-475, 72.5 g of water, 3.3 g of RHEOBYK T-1000VF, and 0.5 g of ACRYSOL RM-825, to afford a flat paint formulation with a KU viscosity of 100±20.

### Stain-Blocking Test

Preparation of Stained Samples. On a smooth, flat substrate (Leneta Plain White Chart, Form WB B #5220, available from Paul N. Gardner Company in Pompano Beach, FL), Flat Basecoat Paint Formulation was applied as a 7 mil (0.1778 mm) wet film basecoat using a U-shaped applicator (#2230, available from BYK-Gardner USA in Columbia, MD). The applied basecoat was allowed to dry for at least 24 hr at room temperature. On the dried basecoat, various staining agents—red permanent marker (Red Sharpie Magnum Permanent Marker from Newell Brands in Atlanta, GA), water-washable black, blue, and green markers (MARKS-A-LOT marker in color black from Avery Products Corp. in Brea, CA; CRAYOLA Window Marker in colors blue and green from Crayola LLC in Forks Township, PA) were applied and allowed to dry for at least 12 hr.

Preparation of Unstained Sample. An unstained sample was prepared by applying the Flat Paint Formulation onto the substrate as a 6 mil (0.1524 mm) wet film, which was air dried at room temperature for at least 24 hr. This was used for standardizing the spectrophotometer.

Application of Example Paints. The Example Paint Formulations (FP Example 1-Example 8 & SGP Example 1-Example 8) were applied over the stained areas using a 3 mil (0.0762 mm) square applicator (4 inch (101.6 mm) width, AP-B5356, Paul N. Gardner Company). The first coat was allowed to dry for at least 2 hr at room temperature before a second coat of the example paints was applied over the dried first coat. The second coat was allowed to dry for at least 1 day before colorimetric measurements were taken.

Measurements. The unstained section of the panel where both coats of the Example Paint meet the Flat Basecoat Paint is used to standardize the spectrophotometer. A calibrated Datacolor Check III spectrophotometer (Lawrenceville, NJ) was used to measure the stained areas of interest to give the color difference, expressed in ΔE, between the stained and the stain-free region. The stain-blocking results, shown in TABLES 8 & 9 below, are averages of at least two repeat measurements. A lower ΔE value indicates better stain-blocking performance.

TABLE 8
Stain-blocking Test for Semi-Gloss Paint (SGP) Examples

| | ΔE over marker stains, | | | |
|---|---|---|---|---|
| | semi-gloss | | | |
| Example Number | Red | Black | Blue | Green |
| SGP Example 1 | 3.8 | 21.1 | 21.9 | 16.5 |
| SGP Example 2 (Comparative) | 1.4 | 28.8 | 20.1 | 18.6 |
| SGP Example 3 | 6.5 | 10.1 | 5.6 | 4.7 |
| SGP Example 4 (Comparative) | 17.7 | 21.9 | 15.3 | 17.9 |
| SGP Example 5 | 1.3 | 22.1 | 12.6 | 12.3 |
| SGP Example 6 (Comparative) | 1.7 | 26.4 | 14.6 | 14.4 |
| SGP Example 7 | 1.6 | 7.1 | 3.7 | 2.3 |
| SGP Example 8 (Comparative) | 6.2 | 14.6 | 4.8 | 6.0 |

TABLE 9
Stain-blocking Test for Flat Paint (FP) Examples

| | ΔE over marker stains, flat | | | |
|---|---|---|---|---|
| Example Number | Red | Black | Blue | Green |
| FP Example 1 | 1.6 | 22.1 | 17.8 | 17.3 |
| FP Example 2 (Comparative) | 2.5 | 24.7 | 19.3 | 14.7 |
| FP Example 3 | 15.4 | 18.3 | 12.4 | 13.4 |
| FP Example 4 (Comparative) | 16.1 | 21.1 | 14.8 | 16.1 |
| FP Example 5 | 1.1 | 17.2 | 13.2 | 11.1 |
| FP Example 6 (Comparative) | 1.4 | 21.7 | 13.9 | 11.7 |
| FP Example 7 | 1.8 | 18.1 | 12 | 9.2 |
| FP Example 8 (Comparative) | 5.7 | 15.7 | 10.1 | 11.1 |

### General Preparation Procedure for Adhesion Test

This adhesion test follows the ASTM 3359-23 cross-cut adhesion method. Each example paint containing an example latex was applied as a 3 mil (0.0762 mm) wet film on an aluminum panel (A-48, 4 inch×8 inch (101.6 mm×203.2 mm), Q-Lab). The example paints were applied on the aluminum panels using a #5554 applicator from BYK-Gardner USA. After air drying for 7 days (168 hr), each paint film was perpendicularly cross-cut using a 6-line, 2-millimeter (2-mm) template with an OLFA Slimline Knife (available from OLFA Corp. in Rosemont, IL) with a fresh sharp blade.

The cross-cut paint films were tested with and without a 30-minute exposure to standing water in the cross-cut regions, the details of these two distinct adhesion tests are described below:
A. Dry adhesion test: A 3-inch (76.2 mm) piece of ELCOMETER 99 adhesive test tape (available from Elcometer in Warren, MI) was applied to the cross-cut region and peeled off at 1800 angle, and the resulting film removal was rated as specified in ASTM 3359 Method B.
B. Wet adhesion test: A 1 in.×1 in. (254 mm×254 mm) piece of paper towel saturated with water was placed on the cross-cut region for 30 minutes, after which the piece of paper towel was removed and the cross-cut region patted dry until no visible moisture remained. Immediately after the drying of the cross-cut region, a 3-inch (76.2 mm) piece of ELCOMETER 99 adhesive test tape (available from Elcometer in Warren, MI) was applied to the cross-cut region and peeled off at 1800 angle, and the resulting film removal was rated as specified in ASTM 3359 Method B.

The adhesion results are shown in TABLE 10 below. The range of the adhesion test score is from 0 to 5, with higher numbers indicating higher adhesion.

TABLE 10
Adhesion to A-48 Aluminum Panel, 7-day Cure

| | |
|---|---|
| Flat | Semi-Gloss |

| Example Number | Dry | Wet | Dry | Wet |
|---|---|---|---|---|
| Example 1 | 4 | 4 | 3 | 3 |
| Example 2 (Comparative) | 4 | 5 | 4 | 4 |
| Example 3 | 4 | 4 | 5 | 0 |
| Example 4 (Comparative) | 4 | 3 | 2 | 1 |
| Example 5 | 4 | 4 | 2 | 2 |
| Example 6 (Comparative) | 3 | 4 | 4 | 3 |
| Example 7 | 3 | 4 | 2 | 5 |
| Example 8 (Comparative) | 3 | 4 | 4 | 3 |

### Scrub Resistance Test

The scrub resistance test follows the ASTM D2486-17 test method. For each example paint, a 7 mil wet film was applied on a Leneta Scrub Test Panel (P-121-10N, available from Paul N. Gardner Company in Pompano Beach, FL) using a U-shaped applicator (#2230, available from BYK-Gardner) and cured at 50% relatively humidity and 75° F. (23.9° C.) for 7 days (168 hr). The dried film was tested on a Washability and Wear Tester (Model D-10, available from Paul N. Gardner Company in Pompano Beach, FL) using a suspension of the SC-2 abrasive scrub medium (from the Leneta Co. in Mahwah, NJ) in water. The numbers of scrubbing cycle needed to achieve visible breakthrough of the film regions being scrubbed are reported in TABLE 11 below.

TABLE 11
ASTM D2486-17 Scrubs Cycles

| Example Number | Flat | Semi-Gloss |
|---|---|---|
| Example 1 | 1424 | 1647 |
| Example 2 (Comparative) | 1435 | 2046 |
| Example 3 | >3200 | >3200 |
| Example 4 (Comparative) | >3200 | >3200 |
| Example 5 | >3200 | 1625 |
| Example 6 (Comparative) | >3200 | 1210 |
| Example 7 | 1788 | 1477 |
| Example 8 (Comparative) | 1800 | 1800 |

The complete disclosures of the patents, patent documents, and publications cited herein are incorporated by reference in their entirety as if each were individually incorporated. To the extent that there is any conflict or discrepancy between this specification as written and the disclosure in any document that is incorporated by reference herein, this specification as written will control. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

1. A stain-blocking paint comprising:
at least 10 wt-%, based on the total nonvolatile weight of the paint, of an emulsion latex polymer comprising interpolymerized monomers comprising:
at least 1 wt-% to less than 20 wt-%, based on the total weight of the interpolymerized monomers, of t-butyl acrylate;
optionally, one or more (meth)acrylate monomers selected from n-butyl (meth)acrylate, ethylhexyl (meth)acrylate, methyl (meth)acrylate, and combinations thereof;
optionally, one or more wet adhesion monomers; and
optionally, styrene;
an aqueous carrier; and
optionally, one or more additives selected from a surfactant, thickener, coalescent, biocide, mildewcide, colorant, and combinations thereof.

2. The paint of claim 1 comprising up to 50 wt-% of the emulsion latex polymer, based on the total nonvolatile weight of the paint.

3. The paint of claim 1, wherein the interpolymerized monomers comprise 10 wt-% to 99 wt-% of the one or more (meth)acrylate monomers, based on the total weight of the interpolymerized monomers.

4. The paint of claim 3, wherein the interpolymerized monomers comprise styrene.

5. The paint of claim 1, wherein the interpolymerized monomers comprise diacetone acrylamide (DAAM).

6. The paint of claim 5, wherein the interpolymerized monomers comprise at least 1 wt-% of DAAM, based on the total weight of the interpolymerized monomers.

7. The paint of claim 1, wherein the interpolymerized monomers comprise one or more wet adhesion monomers, and wherein the interpolymerized monomers comprise 0.2 wt-% to 2.0 wt-% of the one or more wet adhesion monomers, based on the total weight of the interpolymerized monomers.

8. The paint of claim 7, wherein the wet adhesion monomers are selected from the group consisting of N-(2-methacryloyloxyethyl) ethylene urea, 1-(2-((3-(allyloxy)-2-hydroxypropyl)amino)ethyl)imidazolidine-2-one, N-(2-methacryloyloxyethyl) ethylene urea, and combinations thereof.

9. The primer of claim 1, wherein the latex polymer comprises a multi-stage latex that includes two stages having different Tg values, wherein the difference in Tg is at least 35° C.

10. The paint of claim 1, wherein the latex polymer is a multistage latex that includes a soft stage having a Fox Equation Tg of −45 to 10° C. and a hard stage having a Fox Equation Tg of from 30 to 80° C.

11. The paint of claim 1, wherein a hardened coating formed from the paint has a stain-blocking performance, based on the Stain-blocking Test, when the paint is a semi-gloss paint, characterized by a ΔE value of: at most 7 for a red permanent marker; and/or at most 22 for a black water-washable marker; and/or at most 22 for a blue water-washable marker; and/or at most 17 for a green water-washable marker; or a stain-blocking performance, based on the Stain-blocking Test, when the paint is a flat paint, characterized by a ΔE value of: at most 15 for a red permanent marker; and/or at most 19 for a black water-washable marker; and/or at most 18 for a blue water-washable marker; and/or at most 17 for a green water-washable marker.

12. The paint of claim 1, wherein the paint is a topcoat paint.

13. The paint of claim 1, wherein the paint is a paint-and-primer-in-one paint composition.

14. The paint of claim 1, wherein the paint contains less than 7 wt-% volatile organic compounds.

15. A stain-blocking paint comprising:
an emulsion latex polymer comprising interpolymerized monomers comprising:
at least 1 wt-% t-butyl acrylate and optionally one or more acrylic acid ester monomers of Formula (I) other than t-butyl acrylate:
RO—C(O)—CH═CH₂
wherein: R is a branched alkyl having a tertiary carbon atom (in certain embodiments, R has 20 or fewer carbon atoms);
at least 10 wt-% of one or more (meth)acrylate monomers selected from n-butyl (meth)acrylate, ethylhexyl (meth)acrylate, methyl (meth)acrylate, and combinations thereof; and
at least 1 wt-% styrene;
wherein the weight percentages are based on the total weight of the interpolymerized monomers.

16. A stained substrate comprising a stain-blocking paint of claim 1 coated thereon.

17. A stained substrate comprising a stain-blocking paint of claim 15 coated thereon.

18. A method comprising: causing a stain-blocking paint of claim 1 to be applied to a stained substrate.

19. A method comprising: causing a stain-blocking paint of claim 15 to be applied to a stained substrate.

20. A method comprising:
causing a stain-blocking paint to be applied to a stained substrate, the stain-blocking paint comprising an emulsion latex polymer comprising interpolymerized monomers comprising:
at least 1 wt-% to less than 20 wt-%, based on the total weight of the interpolymerized monomers, of t-butyl acrylate;
optionally, one or more (meth)acrylate monomers selected from n-butyl (meth)acrylate, ethylhexyl (meth)acrylate, methyl (meth)acrylate, and combinations thereof;
optionally, one or more wet adhesion monomers; and
optionally, styrene.

21. The paint of claim 1 comprising a coalescent.

22. The paint of claim 21 comprising at least 0.1 wt-% coalescent, based on the total weight of polymer solids.

23. The paint of claim 1, wherein the latex polymer is a single stage latex polymer.

24. The paint of claim 23, wherein the single stage latex polymer comprises interpolymerized monomers comprising styrene.

25. The paint of claim 15 comprising a coalescent.

26. The paint of claim 25 comprising at least 0.1 wt-% coalescent, based on the total weight of polymer solids.

27. The paint of claim 15, wherein the latex polymer is a single stage latex polymer.

28. The paint of claim 27, wherein the single stage latex polymer comprises interpolymerized monomers comprising styrene.

29. The method of claim 20, wherein the paint comprises a coalescent.

30. The method of claim 29 comprising at least 0.1 wt-% coalescent, based on the total weight of polymer solids.

31. The method of claim 20, wherein the latex polymer is a single stage latex polymer.

32. The method of claim 31, wherein the single stage latex polymer comprises interpolymerized monomers comprising styrene.
